(19) United States
(12) Patent Application Publication
(10) Pub. No.: US 2022/0158193 A1
(43) Pub. Date: May 19, 2022

(54) CATHODE ELECTRODE COMPOSITIONS FOR BATTERY APPLICATIONS

(71) Applicant: Cabot Corporation, Boston, MA (US)

(72) Inventors: Aurelien L. DuPasquier, Westford, MA (US); Yakov E. Kutsovsky, Arlington, MA (US); Agathagelos Kyrlidis, Cambridge, MA (US); Deanna Lanigan, Pittsburgh, PA (US); Olha Mashtalir, N. Billerica, MA (US); Miodrag Oljaca, Concord, MA (US); Tushar Shah, Fulton, MD (US); Joseph Zapasnik, Chelmsford, MA (US)

(21) Appl. No.: 17/439,062

(22) PCT Filed: Feb. 21, 2020
(86) PCT No.: PCT/US2020/019199

§ 371 Date: Sep. 14, 2021

Related U.S. Application Data
(60) Provisional application No. 62/822,097, filed on Mar. 22, 2019.

(51) Int. Cl. H01M 4/62; H01M 4/04

(52) U.S. Cl. CPC H01M 4/625; H01M 2004/021; H01M 4/0416; H01M 4/623

(57) ABSTRACT

Carbon nanostructures are used to prepare electrode compositions for lithium ion batteries. In one example, a cathode for NCM batteries includes three-dimensional carbon nanostructures which are made of highly entangled nanotubes, fragments of carbon nanostructures and/or fractured nanotubes which are derived from the carbon nanostructures, are branched and share walls with one another. Amounts of carbon nanostructures employed can be less than or equal to 1 weight % relative to the electrode composition.

### RELATED APPLICATIONS

This application claims the benefit under 35 USC 119(e) of U.S. Provisional Application No. 62/822,097, filed on Mar. 22, 2019, which is incorporated herein by reference in its entirety.

### BACKGROUND OF THE INVENTION

Lithium-ion batteries are commonly used sources of electrical energy for numerous applications ranging from electronic devices to electric vehicles. A lithium-ion battery (LIB) typically includes a negative electrode and a positive electrode in an arrangement that allows lithium ions and electrons to move to and from the electrodes during charging and discharging. An electrolyte solution in contact with the electrodes provides a conductive medium in which the ions can move. To prevent direct reaction between the electrodes, an ion-permeable separator is used to physically and electrically isolate the electrodes. During operation, electrical contact is made to the electrodes, allowing electrons to flow through the device to provide electrical power, and lithium ions to move through the electrolyte from one electrode to the other electrode.

In many cases, the negative electrode is constructed from graphite. The positive electrode typically includes a conductive substrate supporting a mixture (e.g., applied as a paste) having at least an electroactive material, a binder, and a conductive additive. The electroactive material, such as a lithium transition metal oxide, is capable of receiving and releasing lithium ions. The binder, polyvinylidene fluoride (PVDF), for example, is used to provide mechanical integrity and stability to the electrode. Since the electroactive material and the binder often display poor electrically conducting or insulating properties, materials such as graphite and carbon black often are added to enhance the electrical conductivity of the electrode.

### SUMMARY OF THE INVENTION

Some cathode materials used in lithium ion batteries, LFP, NCM and NCA, for instance, can exhibit low electrical conductivities, e.g., 10⁻⁹ siemens per centimeter (S/cm) to 10⁻⁴ S/cm. To avoid battery failure, this performance can be enhanced by constructing a cathode having a conductive network. Some materials with the potential of enhancing performance and avoiding battery failure include conductive carbon black (CB), e.g., with aciniform morphology, and carbon nanotubes (CNTs).

Since, generally, the conductive additive and the binder are not involved in the electrochemical reactions that generate electrical energy, these materials can negatively affect certain performance characteristics (e.g., capacity and energy density) of the battery, as they effectively lower the amount of electroactive material that can be contained in the volume available for the positive electrode.

To construct a conductive cathode network, the amount of CB required is relatively high, typically exceeding 2 percent by weight (wt %). Furthermore, volume expansions and contractions of the cathode can result in loss of contact between CB particles, leading to battery failure.

CNTs may be thought of as attractive materials that have the potential of reducing the amounts of additives to be incorporated in cathode compositions relative to CB amounts. Some difficulties encountered when working with CNTs include limited dispersibility in some media and inadequate purity. It is believed that at least some of these issues are caused by the strong Van der Waals forces that occur between individual carbon nanotubes, causing them to agglomerate into bundles or entanglements. Such manifestations can result in lower than anticipated property enhancements and/or inconsistent performance. In some cases, techniques available for de-bundling carbon nanotubes into individual, well-separated members, can detrimentally impact the desirable property enhancements relative to the enhancements anticipated when using pristine carbon nanotubes.

Often, the low dispersibility of CNTs is addressed by using excess amounts (i.e., more than the theoretical amount) of CNTs. This approach, however, increases production costs, introduces impurities (e.g., iron and cobalt catalysts used to prepare CNTs), and can reduce battery capacity by reducing the battery volume available for the electroactive material.

As a further difficulty, concerns have been raised regarding the environmental health and safety profile of individual carbon nanotubes due to their small size. Also, in the case of some commercial applications, the cost of producing individual carbon nanotubes may be prohibitive.

A need exists, therefore, for conductive additives that can address at least some of these problems. For example, a need exists for additives useful in batteries characterized by high energy density. Materials that can maintain good conductivity even when added at levels of 1 wt % or less are particularly desired.

In some of its aspects, the invention relates to a composition prepared from carbon nanostructures (CNSs). In turn, the composition can be used to prepare electrode compositions, such as, for instance, cathode compositions for lithium ion batteries.

As used herein, the term “carbon nanostructure” or “CNS” refers to a plurality of carbon nanotubes (CNTs)), multiwall (also known as multi-walled) carbon nanotubes (MWCNTs), in many cases, that can exist as a polymeric structure by being interdigitated, branched, crosslinked, and/or sharing common walls with one another. Thus, CNSs can be considered to have CNTs, such as, for instance, MWCNTs, as a base monomer unit of their polymeric structure. Typically, CNSs are grown on a substrate (e.g., a fiber material) under CNS growth conditions. In such cases, at least a portion of the CNTs in the CNSs can be aligned substantially parallel to one another, much like the parallel CNT alignment seen in conventional carbon nanotube forests.

The CNSs can be provided as loose particles (e.g., in the form of pellets, flakes, granules, etc.) or dispersed in a suitable dispersant.

In some embodiments, the invention relates to an electrode composition comprising an electroactive material and at least one material selected from the group consisting of: carbon nanostructures, fragments of carbon nanostructures and fractured carbon nanotubes, e.g., fractured MWCNTs. In many cases, the electroactive material is a lithium transition metal compound.

A method for preparing an electrode composition includes combining a dispersion containing carbon nanostructures with an electroactive material, e.g., a lithium transition metal compound. Another method for preparing an electrode composition includes incorporating carbon nanostructures in a slurry which contains an electroactive material, e.g., a lithium transition metal compound.

Further embodiments relate to electrodes and/or batteries that include CNSs, CNS fragments (that can be derived from CNSs) and/or fractured CNTs), e.g., MWCNTs, (which are derived from CNSs and retain structural features of carbon nanotube branching and shared walls).

In one implementation, a lithium battery comprises: a cathode including a lithium transition metal compound and a first carbon conductive additive; and an anode including an active anode material selected from the group consisting of graphite, silicon or lithium titanate and a second carbon conductive additive. The first and, optionally, the second carbon conductive additive is selected from the group consisting: carbon nanostructures, fragments of carbon nanostructures and fractured carbon nanotubes such as, for instance, fractured MWCNTs.

In some cases, a conductive additive that includes one or more of CNSs, CNS fragments and/or fractured CNTs imparts the desired electrical properties even when the additive is incorporated in relatively low amounts, e.g., 1 weight percent (wt %) or less. It is believed that this effect is due, at least in part, to the formation of fragments that sustain branching, allowing better connectivity between them and creating enhanced conductivity connections. In other situations, an additive such as described herein brings about a cathode capacity and internal resistance that, typically, can only be achieved at higher loadings when using a conventional additive such as, for example, CB. Relative to a comparative electrode composition (containing, e.g., CB, CNTs, or graphene as a conductive additive), an electrode additive according to principles described herein will not typically require the use of higher amounts to achieve the same or essentially the same electrical properties; in many cases, the required levels of the CNS-based additive will be lower than those needed with traditional carbon additives.

Stated differently, use of a composition prepared from a CNS starting material will yield electrodes that exhibit at least the same and often improved electrical properties relative to comparative electrode compositions formulated with conventional carbon additives such as CB, CNTs, graphene, etc. at the same level of loading.

Thus, practicing aspects of the invention can reduce the amount of additive necessary to achieve a certain performance, making possible the production of electrodes that contain higher amounts of active electrode materials (and lesser amounts of conductive additive) in the given electrode volume. In some embodiments, the CNSs employed generate fragments (including partially fragmented CNSs) and/or fractured CNTs. These structures can bring about improved connectivity between one another, thereby enhancing electrical conductivity in the electrode.

CNSs can be provided in forms that are easy to handle and, in some embodiments, form stable dispersions in a desired solvent. Compositions and techniques described herein also address other problems encountered with the use of individual CNTs and/or CB.

Cathode electrodes prepared using CNSs are found to display improved low temperature performance when compared to cathodes made with pristine MWCNTs. Advantages in low temperature performance may also be associated with providing the CNSs via dispersions.

The above and other features of the invention including various details of construction and combinations of parts, and other advantages, will now be more particularly described with reference to the accompanying drawings and pointed out in the claims. It will be understood that the particular method and device embodying the invention are shown by way of illustration and not as a limitation of the invention. The principles and features of this invention may be employed in various and numerous embodiments without departing from the scope of the invention.

### BRIEF DESCRIPTION OF THE DRAWINGS

In the accompanying drawings, reference characters refer to the same parts throughout the different views. The drawings are not necessarily to scale; emphasis has instead been placed upon illustrating the principles of the invention. Of the drawings:

FIGS. 1A and 1B are diagrams illustrating differences between a Y-shaped MWCNT, not in or derived from a carbon nanostructure (FIG. 2A), and a branched MWCNT (FIG. 2B) in a carbon nanostructure;

FIGS. 2A and 2B are TEM images showing features characterizing multiwall carbon nanotubes found in carbon nanostructures;

FIGS. 2C and 2D are SEM images of carbon nanostructures showing the presence of multiple branches;

FIG. 3A is an illustrative depiction of a carbon nanostructure flake material after isolation of the carbon nanostructure from a growth substrate;

FIG. 3B is a SEM image of an illustrative carbon nanostructure obtained as a flake material;

FIG. 4 is a series of plots showing the resistance of cathodes prepared with CNS loadings no greater than 1.5 wt %, compared to that of cathodes prepared CB loadings of 2 wt % and 4 wt %;

FIG. 5 is a series of plots comparing the discharge capacity of electrodes prepared with 0.25 wt % CNS, 2% CB and 4% CB;

FIG. 6 is a series of plots showing direct current internal resistance (DCIR) obtained at different state of charge (SOC) on coin cells made with cathodes composed of 0.25 wt % CNS and comparative 2 wt % and 4 wt % carbon additive;

FIG. 7 is showing in-plane resistance and thru plane conductivity of NCM622 cathodes containing 0.5% CNS, 0.5% CNTs or 1% carbon black (CB);

FIG. 8 is a plot showing the electrode through-plane resistivity obtained from cathode sheets on aluminum foil prepared with selected CCA types and coated on aluminum foil, as a function of CCA weight percent ranging from 0.1 wt % to 1.0 wt %;

FIG. 9 is a plot showing through-plane resistivity of selected NCM electrodes coated on aluminum foil containing 0.5 wt % of conductive additives disclosed herein;

FIG. 10 is a plot showing 0.5C and 2C discharge capacity and HPPC DC-IR at 50% state of charge (SOC) of half coin-cells having NCM622 cathodes using conductive additives disclosed herein;

FIG. 11 is a plot showing 1C discharge capacity retention at −10° C. relative to 1C discharge capacity at +25° C. of half coin-cells having NCM622 cathodes using conductive additives disclosed herein.

### DETAILED DESCRIPTION OF THE PREFERRED EMBODIMENTS

The invention now will be described more fully hereinafter with reference to the accompanying drawings, in which illustrative embodiments of the invention are shown. This invention may, however, be embodied in many different forms and should not be construed as limited to the embodiments set forth herein; rather, these embodiments are provided so that this disclosure will be thorough and complete, and will fully convey the scope of the invention to those skilled in the art.

Generally, the invention relates to a composition that can be used to produce electrodes for batteries, methods of making the composition, and applications of the compositions in electrodes (e.g., cathodes) and batteries. In many of its aspects, the invention relates to a composition suitable for lithium ion batteries. In one example, the batteries of interest are rechargeable lithium ion batteries.

Examples of various types of lithium ion batteries (according to the acronyms for the electroactive material employed, often an intercalation compound) include: LCO (lithium cobalt oxide), LMO (lithium manganese oxide), NCM (lithium nickel cobalt manganese oxide), NCA (lithium nickel cobalt aluminum oxide), LCP (lithium cobalt phosphate), LFP (lithium iron phosphate), LFSF (lithium iron fluorosulfate), LTS (lithium titanium sulfide) and others, as known in the art or as developed in the future. Materials such as these are generally referred to herein as “lithium transition metal compounds”, e.g., “lithium transition metal oxides”.

Some embodiments relate to a composition that consists of, consists essentially of or comprises a conductive additive. The composition is combined with an active electrode material (e.g., NCM or NCA), with or without a binder, to form an electrode composition, in the form of a slurry, typically a paste, that can be applied to a current collector to form an electrode. The electrode can be used to produce a battery.

In many of its aspects, the invention relates to a composition that is prepared using carbon nanostructures (CNSs, singular CNS), a term that refers herein to a plurality of carbon nanotubes (CNTs) that that are crosslinked in a polymeric structure by being branched, e.g., in a dendrimeric fashion, interdigitated, entangled and/or sharing common walls with one another. Operations conducted to prepare the compositions, electrodes and/or batteries described herein can generate CNS fragments and/or fractured CNTs. Fragments of CNSs are derived from CNSs and, like the larger CNS, include a plurality of CNTs that are crosslinked in a polymeric structure by being branched, interdigitated, entangled and/or sharing common walls. Fractured CNTs are derived from CNSs, are branched and share common walls with one another.

Highly entangled CNSs are macroscopic in size and can be considered to have a carbon nanotube (CNT) as a base monomer unit of its polymeric structure. For many CNTs in the CNS structure, at least a portion of a CNT sidewall is shared with another CNT. While it is generally understood that every carbon nanotube in the CNS need not necessarily be branched, crosslinked, or share common walls with other CNTs, at least a portion of the CNTs in the carbon nanostructure can be interdigitated with one another and/or with branched, crosslinked, or common-wall carbon nanotubes in the remainder of the carbon nanostructure.

As known in the art, carbon nanotubes (CNT or CNTs plural) are carbonaceous materials that include at least one sheet of sp²-hybridized carbon atoms bonded to each other to form a honey-comb lattice that forms a cylindrical or tubular structure. The carbon nanotubes can be single-walled carbon nanotubes (SWCNTs) or multi-walled carbon nanotubes (MWCNTs). SWCNTs can be thought of as an allotrope of sp²-hybridized carbon similar to fullerenes. The structure is a cylindrical tube including six-membered carbon rings. Analogous MWCNTs, on the other hand, have several tubes in concentric cylinders. The number of these concentric walls may vary, e.g., from 2 to 25 or more. Typically, the diameter of MWNTs may be 10 nm or more, in comparison to 0.7 to 2.0 nm for typical SWNTs.

In many of the CNSs used in this invention, the CNTs are MWCNTs, having, for instance, at least 2 coaxial carbon nanotubes. The number of walls present, as determined, for example, by transmission electron microscopy (TEM), at a magnification sufficient for analyzing the number of wall in a particular case, can be within the range of from 2 to 30 or so, for example: 4 to 30; 6 to 30; 8 to 30; 10 to 30; 12 to 30; 14 to 30; 16 to 30; 18 to 30; 20 to 30; 22 to 30; 24 to 30; 26 to 30; 28 to 30; or 2 to 28; 4 to 28; 6 to 28; 8 to 28; 10 to 28; 12 to 28; 14 to 28; 16 to 28; 18 to 28; 20 to 28; 22 to 28; 24 to 28; 26 to 28; or 2 to 26; 4 to 26; 6 to 26; 8 to 26; 10 to 26; 12 to 26; 14 to 26; 16 to 26; 18 to 26; 20 to 26; 22 to 26; 24 to 26; or 2 to 24; 4 to 24; 6 to 24; 8 to 24; 10 to 24; 12 to 24; 14 to 24; 16 to 24; 18 to 24; 20 to 24; 22 to 24; or 2 to 22; 4 to 22; 6 to 22; 8 to 22; 10 to 22; 12 to 22; 14 to 22; 16 to 22; 18 to 22; 20 to 22; or 2 to 20; 4 to 20; 6 to 20; 8 to 20; 10 to 20; 12 to 20; 14 to 20; 16 to 20; 18 to 20; or 2 to 18; 4 to 18; 6 to 18; 8 to 18; 10 to 18; 12 to 18; 14 to 18; 16 to 18; or 2 to 16; 4 to 16; 6 to 16; 8 to 16; 10 to 16; 12 to 16; 14 to 16; or 2 to 14; 4 to 14; 6 to 14; 8 to 14; 10 to 14; 12 to 14; or 2 to 12; 4 to 12; 6 to 12; 8 to 12; 10 to 12; or 2 to 10; 4 to 10; 6 to 10; 8 to 10; or 2 to 8; 4 to 8; 6 to 8; or 2 to 6; 4-6; or 2 to 4.

Since a CNS is a polymeric, highly branched and crosslinked network of CNTs, at least some of the chemistry observed with individualized CNTs may also be carried out on the CNS. In addition, some of the attractive properties often associated with using CNTs also are displayed in materials that incorporate CNSs. These include, for example, electrical conductivity, attractive physical properties including good tensile strength when integrated into a composite, such as a thermoplastic or thermoset compound, thermal stability (sometimes comparable to that of diamond crystals or in-plane graphite sheets) and/or chemical stability, to name a few.

However, as used herein, the term “CNS” is not a synonym for individualized, un-entangled structures such as “monomeric” fullerenes (the term “fullerene” broadly referring to an allotrope of carbon in the form of a hollow sphere, ellipsoid, tube, e.g., a carbon nanotube, and other shapes). In fact, many embodiments of the invention highlight differences and advantages observed or anticipated with the use of CNSs as opposed to the use of their CNTs building blocks. Without wishing to be held to a particular interpretation, it is believed that the combination of branching, crosslinking, and wall sharing among the carbon nanotubes in a CNS reduces or minimizes the van der Waals forces that are often problematic when using individual carbon nanotubes in a similar manner.

In addition, or alternatively to performance attributes, CNTs that are part of or are derived from a CNS can be characterized by a number of features, at least some of which can be relied upon to distinguish them from other nanomaterials, such as, for instance, ordinary CNTs (namely CNTs that are not derived from CNSs and can be provided as individualized, pristine or fresh CNTs).

In many cases, a CNT present in or derived from a CNS has a typical diameter of 100 nanometers (nm) or less, such as, for example, within the range of from about 5 to about 100 nm, e.g., within the range of from about 10 to about 75, from about 10 to about 50, from about 10 to about 30, from about 10 to about 20 nm.

In specific embodiments, at least one of the CNTs has a length that is equal to or greater than 2 microns, as determined by SEM. For example, at least one of the CNTs will have a length within a range of from 2 to 2.25 microns; from 2 to 2.5 microns; from 2 to 2.75 microns; from 2 to 3.0 microns; from 2 to 3.5 microns; from 2 to 4.0 microns; or from 2.25 to 2.5 microns; from 2.25 to 2.75 microns; from 2.25 to 3 microns; from 2.25 to 3.5 microns; from 2.25 to 4 microns; or from 2.5 to 2.75 microns; from 2.5 to 3 microns; from 2.5 to 3.5 microns; from 2.5 to 4 microns; or from 3 to 3.5 microns; from 3 to 4 microns; of from 3.5 to 4 microns or higher. In some embodiments, more than one, e.g., a portion such as a fraction of at least about 0.1%, at least about 1%, at least about 10%, at least about 15%, at least about 20%, at least about 25%, at least about 30%, at least about 35%, at least about 40, at least about 45%, at least about 50% or even more than one half, of the CNTs, as determined by SEM, can have a length greater than 2 microns, e.g., within the ranges specified above.

The morphology of CNTs present in a CNS, in a fragment of a CNS or in a fractured CNT derived from a CNS will often be characterized by a high aspect ratio, with lengths typically more than 100 times the diameter, and in certain cases much higher. For instance, in a CNS (or CNS fragment), the length to diameter aspect ratio of CNTs can be within a range of from about 200 to about 1000, such as, for instance, from 200 to 300; from 200 to 400; from 200 to 500; from 200 to 600; from 200 to 700; from 200 to 800; from 200 to 900; or from 300 to 400; from 300 to 500; from 300 to 600; from 300 to 700; from 300 to 800; from 300 to 900; from 300 to 1000; or from 400 to 500; from 400 to 600; from 400 to 700; from 400 to 800; from 400 to 900; from 400 to 1000; or from 500 to 600; from 500 to 700; from 500 to 800; from 500 to 900; from 500 to 1000; or from 600 to 700; from 600 to 800; from 600 to 900; from 600 to 1000; from 700 to 800; from 700 to 900; from 700 to 1000; or from 800 to 900; from 800 to 1000; or from 900 to 1000.

It has been found that in CNSs, as well as in structures derived from CNSs (e.g., in fragments of CNSs or in fractured CNTSs) at least one of the CNTs is characterized by a certain “branch density”. As used herein, the term “branch” refers to a feature in which a single carbon nanotube diverges into multiple (two or more), connected multiwall carbon nanotubes. One embodiment has a branch density according to which, along a two-micrometer length of the carbon nanostructure, there are at least two branches, as determined by SEM. Three or more branches also can occur

Further features (detected using TEM or SEM, for example) can be used to characterize the type of branching found in CNSs relative to structures such as Y-shaped CNTs that are not derived from CNSs. For instance, whereas Y-shaped CNTs, have a catalyst particle at or near the area (point) of branching, such a catalyst particle is absent at or near the area of branching occurring in CNSs, fragments of CNSs or fractured CNTs.

In addition, or in the alternative, the number of walls observed at the area (point) of branching in a CNS, fragment of CNS or fractured CNTs, differ from one side of the branching (e.g., before the branching point) to the other side of this area (e.g., after or past the branching point). Such a change in in the number of walls, also referred to herein as an “asymmetry” in the number of walls, is not observed with ordinary Y-shaped CNTs (where the same number of walls is observed in both the area before and the area past the branching point).

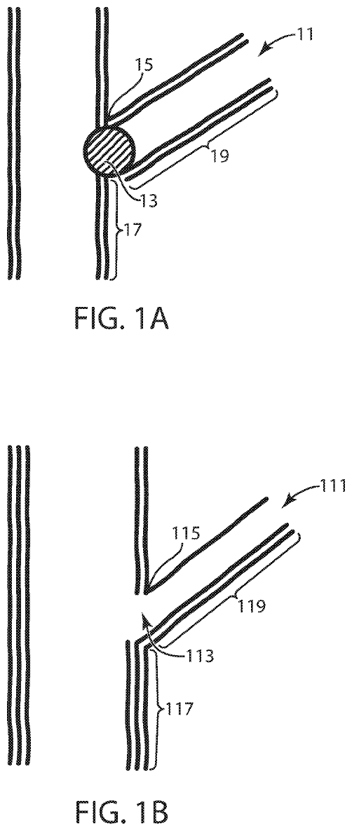

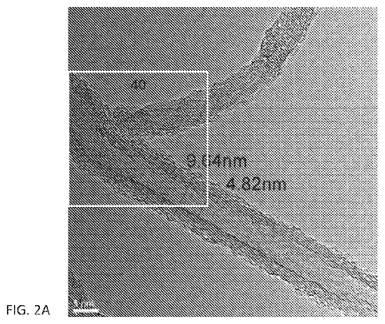

Diagrams illustrating these features are provided in FIGS. 1A and 1B. Shown in FIG. 1A, is an exemplary Y-shaped CNT 11 that is not derived from a CNS. Y-shaped CNT 11 includes catalyst particle 13 at or near branching point 15. Areas 17 and 19 are located, respectively, before and after the branching point 15. In the case of a Y-shaped CNT such as Y-shaped CNT 11, both areas 17 and 19 are characterized by the same number of walls, i.e., two walls in the drawing.

In contrast, in a CNS, a CNT building block 111, that branches at branching point 115, does not include a catalyst particle at or near this point, as seen at catalyst devoid region 113. Furthermore, the number of walls present in region 117, located before, prior (or on a first side of) branching point 115 is different from the number of walls in region 119 (which is located past, after or on the other side relative to branching point 115. In more detail, the three-walled feature found in region 117 is not carried through to region 119 (which in the diagram of FIG. 1B has only two walls), giving rise to the asymmetry mentioned above.

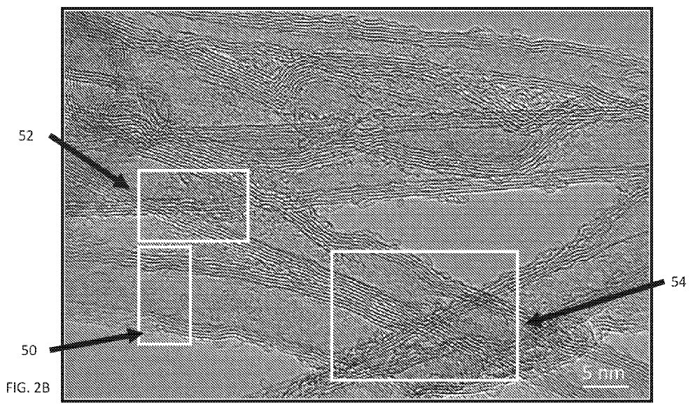

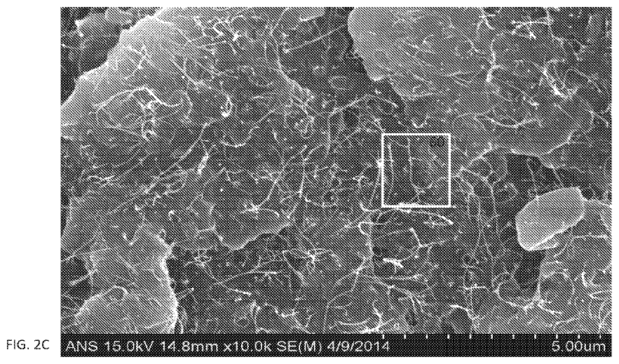

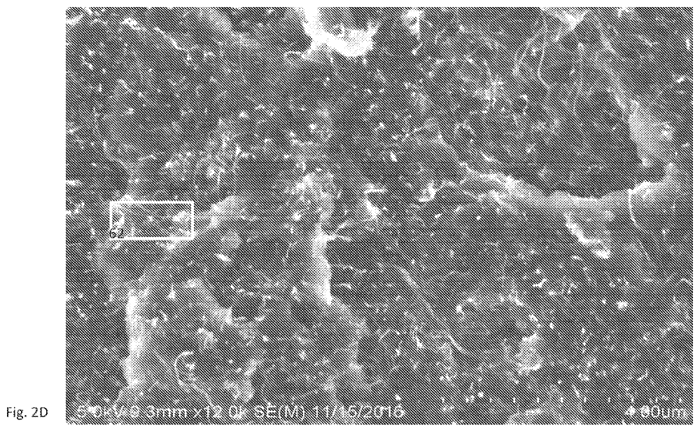

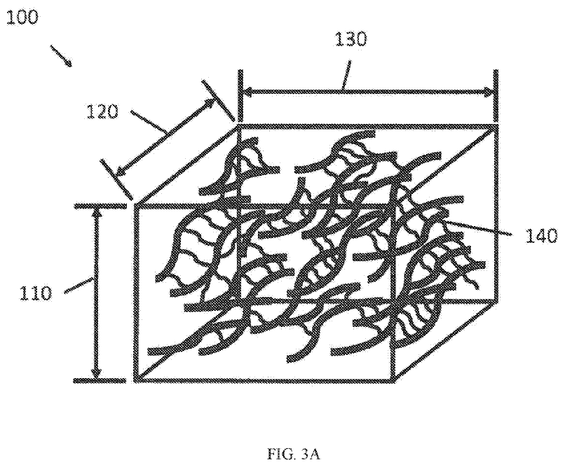

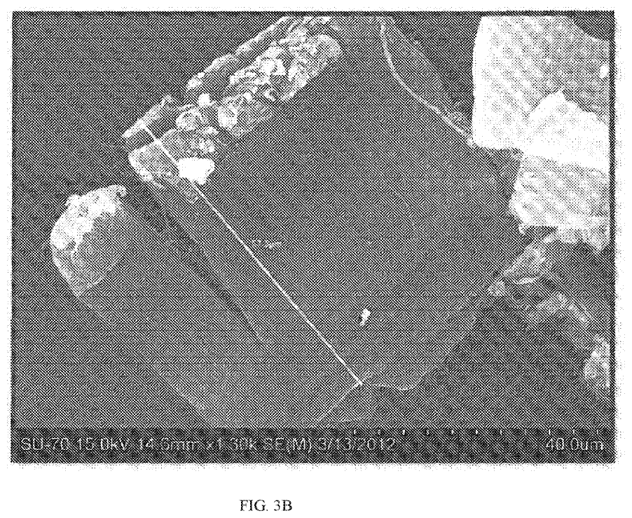

These features are highlighted in the TEM images of FIGS. 2A and 2B and SEM images of FIGS. 2C through 2D.

In more detail, the CNS branching in TEM region 40 of FIG. 2A shows the absence of any catalyst particle. In the TEM of FIG. 2B, first channel 50 and second channel 52 point to the asymmetry in the number of walls featured in branched CNSs, while arrow 54 points to a region displaying wall sharing. Multiple branches are seen in the SEM regions 60 and 62 of FIGS. 2C and 2D, respectively.

One, more, or all these attributes can be encountered in the compositions (e.g., dispersions, slurries, pastes, solid or dried compositions, etc.), electrodes and/or batteries described herein.

In some embodiments, the CNS is present as part of an entangled and/or interlinked network of CNSs. Such an interlinked network can contain bridges between CNSs.

Suitable techniques for preparing CNSs are described, for example, in U.S. Patent Application Publication No. 2014/0093728 A1, published on Apr. 3, 2014, U.S. Pat. Nos. 8,784,937B2; 9,005,755B2; 9,107,292B2; and 9,447,259B2. The entire contents of these documents are incorporated herein by this reference.

As described in these documents, a CNS can be grown on a suitable substrate, for example on a catalyst-treated fiber material. The product can be a fiber-containing CNS material. In some cases, the CNSs is separated from the substrate to form flakes.

As seen in US 2014/0093728A1 a carbon nanostructure obtained as a flake material (i.e., a discrete particle having finite dimensions) exists as a three-dimensional microstructure due to the entanglement and crosslinking of its highly aligned carbon nanotubes. The aligned morphology is reflective of the formation of the carbon nanotubes on a growth substrate under rapid carbon nanotube growth conditions (e.g., several microns per second, such as about 2 microns per second to about 10 microns per second), thereby inducing substantially perpendicular carbon nanotube growth from the growth substrate. Without being bound by any theory or mechanism, it is believed that the rapid rate of carbon nanotube growth on the growth substrate can contribute, at least in part, to the complex structural morphology of the carbon nanostructure. In addition, the bulk density of the CNS can be modulated to some degree by adjusting the carbon nanostructure growth conditions, including, for example, by changing the concentration of transition metal nanoparticle catalyst particles that are disposed on the growth substrate to initiate carbon nanotube growth.

The flakes can be further processed, e.g., by cutting or fluffing (operations that can involve mechanical ball milling, grinding, blending, etc.), chemical processes, or any combination thereof.

In some embodiments, the CNSs employed are “coated”, also referred to herein as “sized” or “encapsulated” CNSs. In a typical sizing process, the coating is applied onto the CNTs that form the CNS. The sizing process can form a partial or a complete coating that is non-covalently bonded to the CNTs and, in some cases, can act as a binder. In addition, or in the alternative, the size can be applied to already formed CNSs in a post-coating process. With sizes that have binding properties, CNSs can be formed into larger structures, granules or pellets, for example. In other embodiments the granules or pellets are formed independently of the function of the sizing.

Coating amounts can vary. For instance, relative to the overall weight of the coated CNS material, the coating can be within the range of from about 0.1 weight % to about 10 weight % (e.g., within the range, by weight, of from about 0.1% to about 0.5%; from about 0.5% to about 1%; from about 1% to about 1.5%; from about 1.5% to about 2%; from about 2% to about 2.5%; from about 2.5% to about 3%; from about 3% to about 3.5%; from about 3.5% to about 4%; from about 4% to about 4.5%; from about 4.5% to about 5%; from about 5% to about 5.5%; from about 5.5% to about 6%; from about 6% to about 6.5%; from about 6.5% to about 7%; from about 7% to about 7.5%; from about 7.5% to about 8%; from about 8% to about 8.5%; from about 8.5% to about 9%; from about 9% to about 9.5%; or from about 9.5% to about 10%.

In many cases, controlling the amount of coating (or size) reduces or minimizes undesirable effects on the properties of the CNS material itself. Low coating levels, for instance, are more likely to preserve electrical properties brought about by the incorporation of CNSs or CNS-derived (e.g., CNS fragments of fractured CNTs) materials in a cathode composition.

Various types of coatings can be selected. In many cases, sizing solutions commonly used in coating carbon fibers or glass fibers could also be utilized to coat CNSs. Specific examples of coating materials include but are not limited to fluorinated polymers such as poly(vinyldifluoroethylene) (PVDF), poly(vinyldifluoroethylene-co-hexafluoropropylene) (PVDF-HFP), poly(tetrafluoroethylene) (PTFE), polyimides, and water-soluble binders, such as poly(ethylene) oxide, polyvinyl-alcohol (PVA), cellulose, carboxymethylcellulose (CMC), starch, hydroxypropylcellulose, regenerated cellulose, polyvinyl pyrrolidone (PVP), and copolymers and mixtures thereof. In many implementations, the CNSs used are treated with a polyurethane (PU), a thermoplastic polyurethane (TPU), or with polyethylene glycol (PEG).

Polymers such as, for instance, epoxy, polyester, vinylester, polyetherimide, polyetherketoneketone, polyphthalamide, polyetherketone, polyetheretherketone, polyimide, phenol-formaldehyde, bismaleimide, acrylonitrile-butadiene styrene (ABS), polycarbonate, polyethyleneimine, polyurethane, polyvinyl chloride, polystyrene, polyolefins, polypropylenes, polyethylenes, polytetrafluoroethylene, elastomers such as, for example, polyisoprene, polybutadiene, butyl rubber, nitrile rubber, ethylene-vinyl acetate polymers, silicone polymers, and fluorosilicone polymers, combinations thereof, or other polymers or polymeric blends can also be used in some cases. In order to enhance electrical conductivity, conductive polymers such as, for instance, polyanilines, polypyrroles and polythiophenes can also be used.

Some implementations employ coating materials that can assist in stabilizing a CNS dispersion in a solvent. In one example, the coating is selected to facilitate and/or stabilize dispersing CNSs in a medium that comprises, consists essentially of or consists of N-methylpyrrolidone (NMP), acetone, a suitable alcohol, water or any combination thereof.

Many embodiments described herein use CNS-materials that have a 97% or higher CNT purity. Typically, anionic, cationic or metal impurities are very low, e.g., in the parts per million (ppm) range. Often, the CNSs used herein require no further additives to counteract Van der Waals' forces.

CNSs can be provided in the form of a loose particulate material (as CNS flakes, granules, pellets, etc., for example) or in compositions that also include a liquid medium, e.g., dispersions, slurries, pastes, or in other forms. In many implementations, the CNSs employed are free of any growth substrate.

In some embodiments, the CNSs are provided in the form of a flake material after being removed from the growth substrate upon which the carbon nanostructures are initially formed. As used herein, the term “flake material” refers to a discrete particle having finite dimensions. Shown in FIG. 1A, for instance, is an illustrative depiction of a CNS flake material after isolation of the CNS from a growth substrate. Flake structure 100 can have first dimension 110 that is in a range from about 1 nm to about 35 μm thick, particularly about 1 nm to about 500 nm thick, including any value in between and any fraction thereof. Flake structure 100 can have second dimension 120 that is in a range from about 1 micron to about 750 microns tall, including any value in between and any fraction thereof. Flake structure 100 can have third dimension 130 that can be in a range from about 1 micron to about 750 microns, including any value in between and any fraction thereof. Two or all of dimensions 110, 120 and 130 can be the same or different.

For example, in some embodiments, second dimension 120 and third dimension 130 can be, independently, on the order of about 1 micron to about 10 microns, or about 10 microns to about 100 microns, or about 100 microns to about 250 microns, from about 250 to about 500 microns, or from about 500 microns to about 750 microns.

The CNTs within the CNS can vary in length from between about 10 nanometers to about 750 microns, for example. In illustrative implementations, the CNTs are from about 10 nanometers to about 100 nanometers, from about 100 nanometers to about 500 nanometers, from about 500 nanometers to about 1 micron, from about 1 micron to about 10 microns, from about 10 microns to about 100 microns, from about 100 microns to about 250 microns, from about 250 to about 500 microns, or from about 500 microns to about 750 microns.

Shown in FIG. 1B is a SEM image of an illustrative carbon nanostructure obtained as a flake material. The carbon nanostructure shown in FIG. 1B exists as a three-dimensional microstructure due to the entanglement and crosslinking of its highly aligned carbon nanotubes. The aligned morphology is reflective of the formation of the carbon nanotubes on a growth substrate under rapid carbon nanotube growth conditions (e.g., several microns per second, such as about 2 microns per second to about 10 microns per second), thereby inducing substantially perpendicular carbon nanotube growth from the growth substrate. Without being bound by any theory or mechanism, it is believed that the rapid rate of carbon nanotube growth on the growth substrate can contribute, at least in part, to the complex structural morphology of the carbon nanostructure. In addition, the bulk density of the carbon nanostructure can be modulated to some degree by adjusting the carbon nanostructure growth conditions, including, for example, by changing the concentration of transition metal nanoparticle catalyst particles that are disposed on the growth substrate to initiate carbon nanotube growth.

A flake structure can include a webbed network of carbon nanotubes in the form of a carbon nanotube polymer (i.e., a “carbon nanopolymer”) having a molecular weight in a range from about 15,000 g/mol to about 150,000 g/mol, including all values in between and any fraction thereof. In some cases, the upper end of the molecular weight range can be even higher, including about 200,000 g/mol, about 500,000 g/mol, or about 1,000,000 g/mol. The higher molecular weights can be associated with carbon nanostructures that are dimensionally long. The molecular weight can also be a function of the predominant carbon nanotube diameter and number of carbon nanotube walls present within the carbon nanostructure. The crosslinking density of the carbon nanostructure can range between about 2 mol/cm³ to about 80 mol/cm³. Typically, the crosslinking density is a function of the carbon nanostructure growth density on the surface of the growth substrate, the carbon nanostructure growth conditions and so forth. It should be noted that the typical CNS structure, containing many, many CNTs held in an open web-like arrangement, removes Van der Wall's forces or diminishes their effect. This structure can be exfoliated more easily, which makes many additional steps of separating them or breaking them into branched structures unique and different from ordinary CNTs.

With a web-like morphology, carbon nanostructures can have relatively low bulk densities. As-produced carbon nanostructures can have an initial bulk density ranging between about 0.003 g/cm³ to about 0.015 g/cm³. Further consolidation and/or coating to produce a carbon nanostructure flake material or like morphology can raise the bulk density to a range between about 0.1 g/cm³ to about 0.15 g/cm³. In some embodiments, optional further modification of the carbon nanostructure can be conducted to further alter the bulk density and/or another property of the carbon nanostructure. In some embodiments, the bulk density of the carbon nanostructure can be further modified by forming a coating on the carbon nanotubes of the carbon nanostructure and/or infiltrating the interior of the carbon nanostructure with various materials. Coating the carbon nanotubes and/or infiltrating the interior of the carbon nanostructure can further tailor the properties of the carbon nanostructure for use in various applications. Moreover, forming a coating on the carbon nanotubes can desirably facilitate the handling of the carbon nanostructure. Further compaction can raise the bulk density to an upper limit of about 1 g/cm³, with chemical modifications to the carbon nanostructure raising the bulk density to an upper limit of about 1.2 g/cm³.

In addition to the flakes described above, the CNS material can be provided as granules, pellets, or in other forms of loose particulate material, having a typical particle size within the range of from about 1 mm to about 1 cm, for example, from about 0.5 mm to about 1 mm, from about 1 mm to about 2 mm, from about 2 mm to about 3 mm, from about 3 mm to about 4 mm, from about 4 mm to about 5 mm, from about 5 mm to about 6 mm, from about 6 mm to about 7 mm, from about 7 mm to about 8 mm, from about 8 mm to about 9 mm or from about 9 mm to about 10 mm.

Bulk densities characterizing CNS materials that can be employed can be within the range of from about 0.005 g/cm³ to about 0.1 g/cm³, e.g., from about 0.01 g/cm³ to about 0.05 g/cm³.

Commercially, examples of CNS materials that can be utilized are those developed by Applied Nanostructured Solutions, LLC (ANS) (Massachusetts, United States).

The CNSs used herein can be identified and/or characterized by various techniques. Electron microscopy, including techniques such as transmission electron microscopy (TEM) and scanning electron microscopy (SEM), for example, can provide information about The CNSs used herein can be identified and/or characterized by various techniques. Electron microscopy, including techniques such as transmission electron microscopy (TEM) and scanning electron microscopy (SEM), for example, can provide information about features such as the frequency of specific number of walls present, branching, the absence of catalyst particles, etc. See, e.g., FIGS. 2A-2D.

Raman spectroscopy can point to bands associated with impurities. For example, a D-band (around 1350 cm⁻¹) is associated with amorphous carbon; a G band (around 1580 cm⁻¹) is associated with crystalline graphite or CNTs). A G′ band (around 2700 cm⁻¹) is expected to occur at about 2× the frequency of the D band. In some cases, it may be possible to discriminate between CNS and CNT structures by thermogravimetric analysis (TGA).

In some embodiments, the CNSs are utilized another CCA, such as, for instance, CB and/or individualized, pristine CNTs, i.e., CNTs that are not generated or derived from CNSs, e.g., during processing.

In many cases, the CB particles employed have a Brunauer-Emmett-Teller (BET) surface area no greater than about 200, 180, 160, 140, 120, 100, 80, 60 or 50 m²/g. In specific examples, the CB particles have a BET that is within the range of from about 200 to about 180 m²/g; from about 200 to about 160 m²/g; 200 to about 140 m²/g; from about 200 to about 120 m²/g; from about 200 to about 100 m²/g, from about 200 to about 80 m²/g; from about 200 to about 60 m²/g; from about 200 to about 50 m²/g; or from about 180 to about 160 m²/g; from about 180 to about 140 m²/g; from about 180 to about 120 m²/g; from about 180 to about 100 m²/g, from 180 to about 80 m²/g; from about 180 to about 60 m²/g; from 180 to about 50 m²/g; or from about 160 to about 140 m²/g; from about 160 to about 120 m²/g; from about 160 to about 100 m²/g, from 160 to about 80 m²/g; from about 160 to about 60 m²/g; from 160 to about 50 m²/g; or from about 140 to about 120 m²/g; or from about 140 to about 100 m²/g, from 140 to about 80 m²/g; from about 140 to about 60 m²/g; from 140 to about 50 m²/g; or from about 120 to about 100 m²/g, from 120 to about 80 m²/g; from about 120 to about 60 m²/g; from 120 to about 50 m²/g; or from about 100 to about 80 m²/g; from about 100 to about 60 m²/g; from 100 to about 50 m²/g; or from about 80 to about 60 m²/g; from 80 to about 50 m²/g; or from about 60 to about 50 m²/g. All BET surface area values disclosed herein refer to “BET nitrogen surface area” and are determined by ASTM D 6556-10, the entirety of which is incorporated herein by reference.

Suitable CBs can have an oil adsorption number (OAN) of at least 130 mL/100 g, 140, 150, 160, 170, 180, 190, 200, 210, 220, 230, 240 or 250 mL/100 g. Exemplary CBs have an OAN within the range of from about 130 to about 150 mL/100 g; from about 130 to about 170 mL/100 g; from about 130 to about 190 mL/100 g; from about 130 to about 210 mL/100 g; from about 130 to about 230 mL/100 g; from 130 to about 250 mL/100 g or higher; or from about 150 to about 170 from about 150 to about 190; from about 150 to about 210; from about 150 to about 230 mL/100 g; from about 150 to about 250 mL/100 g or higher; or from 170 to about 190 mL/100 g; from about 170 to about 210; from about 170 to about 230 mL/100 g; from about 170 to about 250 mL/100 g or higher; or from about 190 to about 210 mL/100 g; from about 190 to about 230 mL/100 g; from about 190 to about 250 mL/100 g or higher; or from about 210 to about 230 mL/100 g; from about 210 to about 250 mL/100 g or higher; or from about 230 to about 250 mL/100 g or higher. All OAN values cited herein are determined by the method described in ASTM D 2414-16, which is incorporated herein by reference.

Carbon black particles also can be characterized by their statistical thickness surface areas (STSAs), a property that can be determined by ASTM D 6556-10. For a given carbon black, it may also be of interest, in some cases, to specify the ratio of its STSA to its BET surface area (STSA:BET ratio). For the purpose of this application, the STSA:BET ratio for carbon black particles can be within the range of about 0.3 to about 1.

Crystalline domains can be characterized by an Lₐ crystallite size, as determined by Raman spectroscopy. Lₐ is defined as 43.5×(area of G band/area of D band). The crystallite size can give an indication of the degree of graphitization, where a higher Lₐ value correlates with a higher degree of graphitization. Raman measurements of Lₐ were based on Gruber et al., “Raman studies of heat-treated carbon blacks,” Carbon Vol. 32 (7), pp. 1377-1382, 1994, which is incorporated herein by reference. The Raman spectrum of carbon includes two major “resonance” bands at about 1340 cm⁻¹ and 1580 cm⁻¹, denoted as the “D” and “G” bands, respectively. It is generally considered that the D band is attributed to disordered sp² carbon, and the G band to graphitic or “ordered” sp² carbon. Using an empirical approach, the ratio of the G/D bands and an Lₐ measured by X-ray diffraction (XRD) are highly correlated, and regression analysis gives the empirical relationship:

Lₐ=43.5×(area of G band/area of D band),

in which Lₐ is calculated in Angstroms. Thus, a higher Lₐ value corresponds to a more ordered crystalline structure.

In some embodiments, the carbon black has an Lₐ crystallite size of less than or equal to 35 Å, for example, from 25 Å to 35 Å. The Lₐ crystallite size can have or include, for example, one of the following ranges: from 25 to 33 Å, or from 25 to 31 Å, or from 25 to 29 Å, or from 25 to 27 Å, or from 27 to 35 Å, or from 27 to 33 Å, or from 27 to 31 Å, or from 27 to 29 Å, or from 29 to 35 Å, or from 29 to 33 Å, or from 29 to 31 Å, or from 31 to 35 Å, or from 31 to 33 Å, or from 33 to 35 Å. In certain embodiments, the Lₐ crystallite size can be less than or equal to 33 Å, or less than or equal to 31 Å, or less than or equal to 29 Å, or less than or equal to 27 Å.

The crystalline domains can be characterized by an L_{c} crystallite size. The L_{c} crystallite size was determined by X-ray diffraction using an X-ray diffractometer (PANalytical X'Pert Pro, PANalytical B.V.), with a copper tube, tube voltage of 45 kV, and a tube current of 40 mA. A sample of carbon black particles was packed into a sample holder (an accessory of the diffractometer), and measurement was performed over angle (2θ) range of 10° to 80°, at a speed of 0.14°/min. Peak positions and full width at half maximum values were calculated by means of the software of the diffractometer. For measuring-angle calibration, lanthanum hexaboride (LaB₆) was used as an X-ray standard. From the measurements obtained, the L_{c} crystallite size was determined using the Scherrer equation: L_{c} (Å)=K*λ/(β*cos θ), where K is the shape factor constant (0.9); λ is the wavelength of the characteristic X-ray line of Cu K_{α1} (1.54056 Å); β is the peak width at half maximum in radians; and θ is determined by taking half of the measuring angle peak position (2θ).

In some embodiments, the carbon black has an L_{c} crystallite size of less than or equal to 27 Å, for example, from 15 Å to 27 Å. The L_{c} crystallite size can have or include, for example, one of the following ranges: from 15 to 25 Å, or from 15 to 23 Å, or from 15 to 21 Å, or from 15 to 19 Å, or from 15 to 17 Å, or from 17 to 27 Å, or from 17 to 25 Å, or from 17 to 23 Å, or from 17 to 21 Å, or from 17 to 19 Å, or from 19 to 27 Å, or from 19 to 25 Å, or from 19 to 23 Å, or from 19 to 21 Å, or from 21 to 27 Å, or from 21 to 25 Å, or from 21 to 23 Å, or from 23 to 27 Å, or from 23 to 25 Å, or from 25 to 27 Å. In certain embodiments, the L_{c} crystallite size can be less than or equal to 25 Å, or less than or equal to 23 Å, or less than or equal to 21 Å, or less than or equal to 19 Å, or less than or equal to 17 Å.

The carbon black particles can have a high degree of graphitization, as indicated by a high % crystallinity, which is obtained from Raman measurements as a ratio of the area of the G band and the areas of G and D bands (I_{G}/I_{G+D}). In certain embodiments, the carbon black particles have % crystallinities (I_{G}/I_{G+D}) ranging from about 25% to about 45%, as determined by Raman spectroscopy. The % crystallinity (I_{G}/I_{G+D}) can have or include, for example, one of the following ranges: from 25% to 43%, from 25% to 41%, from 25% to 37%, from 25% to 39%, from 25% to 35%, from 25% to 30%, from 25% to 28%; or from 30% to 45%, from 30% to 43%, from 30% to 39%, from 30% to 35%; or from 35% to 45%, from 35% to 41%, from 35% to 39%; or from 37% to 45%, from 37% to 43%, from 37% to 41%; or from 39% to 45%, from 39% to 43%; or from 41% to 45%, or from 41% to 43%.

Some CB specifications characterized by these and/or other properties known and recognized by those skilled in the art are shown as specifications A-F in Table 1.

TABLE 1

| | | | | | (I_{G}/(I_{G} + I_{D})) | |
|---|---|---|---|---|---|---|
| CB | BET SA, | STSA, | OAN, | Lₐ Raman | % Cr, | L_{c} XRD |
| Specification | m²/g | m²/g | mL/100 g | Å | Raman | Å |
| A | 154 | 135 | 161 | 31 | 42 | 21 |
| B | 169 | 144 | 155 | 24 | 38 | 19 |
| C | 100 | 100 | 250 | 27 | 39 | 21 |
| D | 58 | 58 | 200 | 28 | 39 | 20 |
| E | 390 | 145 | 170 | 19 | 30 | 14 |
| F | 55 | 55 | 140 | 17 | 28 | 15 |

Suitable CB particles that can be utilized can be commercially available particles. Examples include LITX® 50, LITX® 66, LITX® 200, LITX® 300, LITX® HP and Vulcan® 500 carbon black particles available from Cabot Corporation; C-NERGY™ C45, C-NERGY™ C65 and SUPER P® products from Imerys; Li-400, Li-250, Li-100 and Li-435 products from Denka; and the EC300 product from Ketjen.

Other materials that could be used in conjunction with CNSs are illustrated by specification L-N (Table 2, below) describing exemplary CNTs.

TABLE 2

| | | | | | (I_{G}/(I_{G} + I_{D})) | |
|---|---|---|---|---|---|---|
| CB | BET SA, | STSA, | OAN, | Lₐ Raman | % Cr, | L_{c} XRD |
| Specification | m²/g | m²/g | mL/100 g | Å | Raman | Å |
| L | 230 | N/A | N/A | 52.5 | 55 | 45 |
| M | 170 | N/A | N/A | 30 | 40 | 41 |
| N | 191 | N/A | N/A | 56 | 55 | 31 |

Values presented in Table 2 are typically determined using the techniques described above with respect to CB.

In many situations, the CNS material (in the form of flakes, pellets, granules, for instance) is provided in combination with or in the presence of a liquid medium. In general, the liquid medium can be any liquid, a solvent, for instance, that is suitable for use with the constituents of the compositions described herein and capable of being used to manufacture the intended electrode. The solvent can be anhydrous, polar and/or aprotic. In some embodiments, the solvent has a high volatility so that, during manufacturing, it can be easily removed (e.g., evaporated), thereby reducing drying time and production costs. Suitable examples include but are not limited to N-methylpyrrolidone (NMP), acetone, a suitable alcohol, water or any combination thereof.

In some cases, the composition further includes one or more dispersants (e.g., a cellulosic dispersant), and/or one or more additives, typically electrically non-conductive additives, such as a maleic anhydride polymer, for example.

The dispersant generally includes a material capable of facilitating the dispersion of the CNSs in the solvent (e.g., via a steric hindrance mechanism and/or an electrostatic charge mechanism), while keeping the viscosity of the compositions sufficiently low to enable practical processing of the compositions, e.g., for the manufacturing of electrodes for batteries. In some embodiments, for compositions including the CNSs, the dispersant, the polymer and the solvent have a viscosity of equal to or less than 200 centipoise (cP) at a shear rate of 450 s⁻¹, for example, at least 30 cP at a shear rate of 450 s⁻¹, or from 50 cP to 140 cP at a shear rate of 450 s⁻¹, as determined by rheometer. In various embodiments, the compositions can be described as a slurry, e.g., a paste that can be readily applied or coated to a conductive substrate to form an electrode, as contrasted with a mud that is too thick or viscous to be efficiently applied during manufacturing. In addition to its ability to disperse the CNS material, the dispersant preferably is thermally stable, is electrochemically inert, and/or interferes minimally with the electrical conductivity of CNS material. A thermally stable or non-volatile dispersant allows the solvent (e.g., N-methylpyrrolidone, water, etc.) to be removed and recycled during electrode manufacturing without removing and/or degrading the dispersant. “Electrochemically inert” means that the dispersant is stable during normal use of the battery (e.g., does not degrade or oxidize at or below the operating voltages of the battery) since such degradation can negatively affect the performance of the battery. Furthermore, since the dispersant coats at least portions of the CNS flakes, granules, pellets, etc. to disperse the particles, the dispersant could interfere with or reduce the conductive contact surfaces available to the particles. Thus, it is preferable to select a dispersant that minimally interferes with the electrical conductivity of the CNS particles. In embodiments in which the compositions further include one or more electroactive materials, the dispersant (e.g., polyvinylpyrrolidone) is capable of reducing phase separation and/or settling of the electroactive material.

Examples of suitable dispersants include poly(vinyl pyrrolidone), poly(vinylpyrrolidone-co-vinyl acetate), poly(vinyl butyral) (or PVB), poly(vinyl alcohol), poly(ethylene oxide), poly(propylene oxide), poly(propylene carbonate), cellulosic dispersants such as methyl cellulose, carboxymethyl cellulose, ethyl cellulose, hydroxymethyl cellulose and hydroxypropyl cellulose; poly(carboxylic acid) such as poly (acrylic acid), polyacrylate, poly(methylacrylate), poly(acrylamide), amide wax, styrene maleic anhydride resins, octylphenol ethoxylate, multifunctional co-dispersants such as AMP™ dispersants, containing 2-amino-2-methyl-1-propanol, various derivatives and others known in the art. The compositions can include one or more than one dispersant(s) or one or more than one dispersant formulation(s).

In one illustration, the dispersant belongs to a class that includes a styrene maleic anhydride resin and/or its derivatives, the latter being polymers made via a chemical reaction of styrene maleic anhydride resin or prehydrolyzed styrene maleic anhydride resin with small or large organic molecules having at least one reactive end group, for example an amine or epoxide group. In general, this class of polymeric dispersants (also referred to herein as styrene maleic anhydride-based) have a styrene maleic anhydride copolymer backbone modified with various polymeric brushes and/or small molecules.

In another illustration, the dispersant includes PVP (in various molecular weights) or its derivatives, the latter generally referring to dispersants that have a PVP backbone modified with small or large molecules via chemical reactions, for example. Examples of PVP-based dispersants include Ashland PVP K-12, K-15, K-30, K-60, K-90 and K-120 products, polyvinyl pyrrolidone copolymers such as polyvinyl pyrrolidone-co-vinyl acetate, butylated polyvinyl pyrrolidone such as Ganex™ P-904LC polymer.

In a further illustration, the dispersant is a cellulose-based dispersant, including, for instance, cellulose or cellulose derivatives, the latter having a cellulose backbone optionally modified by small or large organic molecules having at least one reactive end group. In one specific example, the cellulose-based dispersant is CMC (e.g., at various viscosities), a compound typically prepared by the reaction of cellulose with chloroacetic acid. In another example, the dispersant is hydroxyethyl cellulose.

Other possible candidates include sodium dodecyl sulfate (SDS), sodium, dodecyl benzyl sulfonate, derivatives of polyacrylic acid and so forth.

In some cases, the dispersant used may be a dispersant available under the tradename of DISPERBYK® or BYK®, from BYK.

A dispersant, e.g., a PVP-based dispersant, can be combined with additional dispersants such as, for instance, AMP™ and/or PVB.

The concentration of the dispersant in the compositions can vary, depending on the dispersant or dispersant formulation employed, the specific type(s) and concentrations of CNS, the polymer, and the solvent. In some embodiments, the concentration of the dispersant is best expressed as a ratio of the dispersant to the CNS material, by weight. This weight ratio can range from 3:100 to 50:100 and can have or include, for example, one of the following ranges: 3:100 to 40:100, or 3:100 to 30:100, or 3:100 to 20:100, or 3:100 to 10:100, or 10:100 to 50:100, or 10:100 to 40:100, or 10:100 to 30:100, or 10:100 to 20:100, or 20:100 to 50:100, or 20:100 to 40:100, or 20:100 to 30:100, or 30:100 to 50:100, or 30:100 to 40:100, or 40:100 to 50:100.

In some cases, the concentration of a maleic anhydride-derived polymer in the compositions varies, depending on the composition(s) of the polymer used, and the specific type(s) and concentrations of the CNS material, the dispersant(s), and the solvent. In some embodiments, the compositions include from 0.1 wt % to 1.0 wt % of the polymer. The concentration of the polymer in the compositions can be, for example, in one of the following ranges: 0.1 wt % to 0.8 wt %, or 0.1 wt % to 0.6 wt %%, or 0.1 wt % to 0.4 wt %%, or 0.3 wt % to 1.0 wt %%, or 0.3 wt % to 0.8 wt %%, or 0.3 wt % to 0.6 wt %%, or 0.5 wt % to 1.0 wt %%, or 0.5 wt % to 0.8 wt %%, or 0.7 wt % to 1.0 wt %. In various embodiments, the concentration of the polymer is expressed as a ratio of the dispersant to the CNS material by weight. The weight ratio of polymer to CNS can range from 0.1:100 to 2:100 and can have or include, for example, one of the following ranges: 0.1:100 to 1.5:100, or 0.1:100 to 1:100, or 0.1:100 to 0.5:100, or 0.5:100 to 2:100, or 0.5:100 to 1.5:100, or 0.5:100 to 1:100, or 1:100 to 2:100, or 1:100 to 1.5:100, or 1.5:100 to 2:100.

One illustration employs 1.6 wt % CNS/0.32 wt % PVP-based dispersant; another illustration employs 1.5 wt % CNS/0.5 wt %/BYK® 2155; a further illustration utilizes 1.5 wt % CNS/0.32 wt % AMP/PVB/BYK® 2155; yet another contains 1 wt % CNS/0.2 wt % AMP/PVB/BYK® 2155.

Dispersions containing CNSs can be premade and, in some cases, may be available commercially, from Cabot Corporation, for example.

The CNS material can be combined with the liquid, optionally in the presence of a dispersant, by a suitable mixing technique, using, for example, conventional mixing equipment. In specific embodiments, the constituents are blended to form a composition, a solution or dispersion, for example. The composition can be characterized, for instance, by a concentration of CNS in the solvent of from about 0.25 to about 2.5 weight %. In illustrative examples, the concentration in wt % is within a range of from about 0.25 to about 0.5, from about 0.5 to about 0.75, from about 0.75 to about 1.0, from about 1.0 to about 1.25, from about 1.25 to about 1.50, from about 1.50 to about 1.75, from about 1.75 to about 2.0, from about 2.0 to about 2.25, or from about 2.25 to about 2.5. Other concentrations of CNS in solvent can be employed.

Unlike ordinary solutions or dispersions that use ordinary, individualized CNTs, e.g., in pristine form, CNSs, in particular when provided as post-coated CNSs in the form of granules or pellets, can yield stable dispersions. In some embodiments, stable dispersions can be achieved in the absence of stabilizing surfactants, even with water as solvent. Other embodiments utilize a solvent in combination with water during wet processing. Examples of solvents that can be used include, but are not limited to, isopropanol (IPA), ethanol, methanol, and water.

In some cases, techniques used to prepare the dispersion generate CNS-derived species such as “CNS fragments” and/or “fractured CNTs” that become distributed (e.g., homogeneously) in individualized form throughout the dispersion. Except for their reduced sizes, CNS fragments (a term that also includes partially fragmented CNSs) generally share the properties of intact CNS and can be identified by electron microscopy and other techniques, as described above. Fractured CNTs can be formed when crosslinks between CNTs within the CNS are broken, under applied shear, for example. Derived (generated or prepared) from CNSs, fractured CNTs are branched and share common walls with one another.

A composition consisting of or consisting essentially of a CNS material, or a composition prepared from CNSs, e.g., a dispersion such as described above, is combined with other ingredients. It can be used, for instance, in the production of any number of energy storage devices, such as lithium-ion batteries. As an example, the composition is employed to produce an electrode (e.g., cathode) composition for a lithium-ion battery. In many embodiments, the composition is combined with an electroactive material (components) specific to a particular type of electrode.

Many cathode materials normally used in lithium-ion batteries are based on intercalation chemistry, and typically involve chemical reactions that transfer a single electron. Other types of cathode materials (having lithium ions inserted into FeF₃, for instance) can transfer multiple electrons through more complex reaction mechanisms, called conversion reactions.

Examples of suitable electroactive materials include but are not limited to LCO, LMO, NCM, NCA, LCP, LFP, LFSF, LTS and others, as known in the art or as developed in the future. In some embodiments, the CNS-containing composition described above is used with NCM or NCA electrode compositions. A binder such as poly(vinyldifluoroethylene) (PVDF), for instance, often is included.

NCM (also referred to as “NMC”) and NCA are generally known to those skilled in the art of batteries.

In more detail, NCM can be represented by the formula Li₁₊ₓ(Ni_{y}Co_{1-y-z}Mn_{z})₁₋ₓO₂, wherein x ranges from 0 to 1, y ranges from 0 to 1 (e.g., 0.3-0.8), and z ranges from 0 to 1 (e.g., 0.1-0.3). Examples of NCMs include Li₁₊ₓ(Ni_{0.33}Co_{0.33}Mn_{0.33})₁₋ₓO₂, Li₁₊ₓ(Ni_{0.4}Co_{0.3}Mn_{0.3})₁₋ₓO₂, Li₁₊ₓ(Ni_{0.4}Co_{0.2}Mn_{0.4})₁₋ₓO₂, Li₁₊ₓ(Ni_{0.4}Co_{0.1}Mn_{0.5})₁₋ₓO₂, Li₁₊ₓ(Ni_{0.5}Co_{0.1}Mn_{0.4})₁₋ₓO₂, Li₁₊ₓ(Ni_{0.5}Co_{0.3}Mn_{0.2})₁₋ₓO₂, Li₁₊ₓ(Ni_{0.5}Co_{0.2}Mn_{0.3})₁₋ₓO₂, Li₁₊ₓ(Ni_{0.6}Co_{0.2}Mn_{0.2})₁₋ₓO₂, and Li₁₊ₓ(Ni_{0.8}Co_{0.1}Mn_{0.1})₁₋ₓO₂.

NCA can be represented by the formula Li₁₊ₓ(Ni_{y}Co_{1-y-z}Al_{z})₁₋ₓO₂, wherein x ranges from 0 to 1, y ranges from 0 to 1, and z ranges from 0 to 1. An example of an NCA is Li₁₊ₓ(Ni_{0.8}Co_{0.15}Al_{0.05})₁₋ₓO₂.

The concentration of NCM or NCA in the electrode composition can vary, depending on the particular type of energy storage device. In some cases, the NCM or NCA is present in the electrode composition in an amount of at least 90% by weight, e.g., greater than 95% by weight, relative to the total weight of the electrode composition, e.g., an amount ranging from 90% to 99% by weight, relative to the total weight of the electrode composition.

In some embodiments, the electrode composition contains one or more binders, used, e.g., to enhance the mechanical properties of the formed electrode. Exemplary binder materials include, but are not limited to, fluorinated polymers such as poly(vinyldifluoroethylene) (PVDF), poly(vinyldifluoroethylene-co-hexafluoropropylene) (PVDF-HFP), poly(tetrafluoroethylene) (PTFE), polyimides, and water-soluble binders, such as poly(ethylene) oxide, polyvinyl-alcohol (PVA), cellulose, carboxymethylcellulose (CMC), starch, hydroxypropylcellulose, regenerated cellulose, polyvinyl pyrrolidone (PVP), and copolymers and mixtures thereof. Other possible binders include polyethylene, polypropylene, ethylene-propylene-diene terpolymer (EPDM), sulfonated EPDM, styrene-butadiene rubber (SBR), and fluoro rubber and copolymers and mixtures thereof.

The binder can be present in the cathode composition in an amount of 1 to 10% by weight, e.g., 1-2, 2-3, 3-4, 4-5, 5-6, 6-7, 7-8, 8-9 or 9-10 wt %.

In some implementations, the CNS loading relative to a dry electrode composition such as used in a NCM electrode for lithium batteries, for instance, is less than 2 wt %, for example less than 1.9, 1.8, 1.7 or 1.6 wt %. In other embodiments, the CNS loading in a dry electrode composition such as used in a NCM electrode for lithium batteries, for instance, is 1.5 wt % or less, e.g., at least 1.4, 1.3, 1.2, 1.2, 1.0, 0.95, 0.90, 0.85, 0.80, 0.75, 0.70, 0.65, 0.60, 0.55, 0.50, 0.45, 0.40, 0.35, 0.30, 0.25, 0.20, 0.15 or 0.10, wt %. In one example, the CNS amount used to prepare the cathode composition is compared to the lowest concentration at which the resulting dry cathode composition becomes conductive (i.e., the percolation threshold).

The electrode composition can be prepared by combining (e.g., by uniformly mixing) the constituents described above, which can be added in any order designed to obtain the mixture and in particular a mixture that is homogeneous. Suitable mixing techniques include mechanical agitation, shaking, stirring, etc.

In one example, an electrode (e.g., cathode) composition is made by homogeneously interspersing (e.g., by uniformly mixing) a composition consisting of consisting essentially of, or comprising CNSs, or a composition prepared using a CNS starting material, with the NCM or NCA component. In another example, a binder is homogeneously interspersed with a CNS-containing composition and with NCM or NCA, for example.

When provided in some forms, e.g., in granules, pellets, or flake form, CNSs can be directly incorporated in a slurry containing the active electrode material (e.g., NCM or NCA).

In other embodiments, pellets, granules, flakes or other forms of CNSs are first dispersed in a liquid medium, e.g., NMP, generating CNS fragments (including partially fragmented CNSs) and/or fractured CNTs. The dispersion can be prepared from a starting material such as, for example, uncoated, PU- or PEG-coated CNS, or CNSs having any other polymeric binder coating.

Specific implementations feature dispersions prepared from CNSs and a PVP-based dispersant, for instance. Another illustration uses dispersions prepared from BYK® 2155, optionally in the presence of AMP™ and/or PVB. In some examples the cathode compositions are prepared from: 98.25 wt % NCM622+0.25 wt % CNS+1.5 wt % PVDF (e.g., KF7200, manufactured by Kureha Corp.); or 98 wt % NCM622+0.5 wt % CNSs+1.5 wt % PVDF.

In one implementation, the electroactive material, NCM, for example, is added, in the presence of a solvent such as NMP, to a mixture of CNS granules, pellets, flakes, etc., a liquid medium, e.g., NMP, and a binder (PVDF, for instance). Illustrative CNS fragment sizes present in the dispersion can be within the range of from about 0.5 to about 20 μm, e.g., within the range of from about 0.5 to about 1 μm; from about 1 to about 5 μm; from about 5 to about 10 μm; from about 10 to about 15 μm; or from about 15 to about 20 μm. In some cases, reducing the fragment size too much, e.g., to less than 0.5 μm, can compromise the electrical properties associated with utilizing CNSs.

The resulting electrode composition can take the form of a slurry (e.g., a paste) that combines particulate NCM or NCA, a CNS-based conductive additive, dispersant(s) (if present), nonconductive additive(s) (if present), solvent, and binder (if present). In other embodiments, the electrode composition is a solid formed by the removal of solvent from the slurry. Drying techniques that can be employed include air drying, heating (in a suitable oven, for instance) and so forth.

A battery electrode can be formed by applying an electrode composition such as described above, e.g., in the form of a paste, onto an electrically conducting substrate (e.g., an aluminum current collector), followed by removing the solvent. The paste can be applied by techniques such as doctor blade coating, reverse comma bar coating or extrusion.

In some implementations, the paste has a sufficiently high solids loading (i.e., high concentration of solids) to enable deposition onto the substrate while minimizing the formation of inherent defects (e.g., cracking) that may result with a less viscous paste (e.g., having a lower solid loading). Moreover, a higher solids loading reduces the amount of solvent needed and its removal.

Solvent is removed by drying the paste, either at ambient temperature or under low heat conditions, e.g., temperatures ranging from 20° to 100° C. The deposited electrode/current collector can be cut to the desired dimensions, optionally followed by calendering.

The process leading to the formation of the electrode can preserve the integrity of at least some of the initial CNSs used, which will remain intact. Some process operations and/or conditions, however, can alter at least some of the initial CNSs employed. As described above, one example involving such an operation and/or condition is the application of shear forces, as encountered, for instance, when preparing an emulsion from a CNS starting material.

In some situations, an initial CNS is broken into smaller CNS units or fragments. Except for their reduced sizes, these fragments generally share the properties of intact CNS and can be identified by electron microscopy and other techniques, as described above.

Also possible are changes in the initial nanostructure morphology of the CNS. For example, applied shear can break crosslinks between CNTs within a CNS to form CNTs that typically will be dispersed as individual CNTs in the electrode composition. It is found that structural features of branching and shared walls are retained for many of these CNTs, even after the crosslinks are removed. CNTs that are derived (prepared) from CNSs and retain structural features of CNT branching and shared walls are referred to herein as “fractured” CNTs. These species are capable of imparting improved interconnectivity (between CNT units), resulting in better conductivity at lower concentrations.

Thus, in comparison to electrodes or electrode compositions that employ ordinary, individualized CNTs, e.g., in pristine form, electrodes and electrode compositions described herein will often include fractured CNTs. These fractured CNTs can readily be differentiated from ordinary carbon nanotubes through standard carbon nanotube analytical techniques, such as SEM, for example. It is further noted that not every CNT encountered needs to be branched and share common walls; rather it is a plurality of fractured CNTs, that, as a whole, will possess these features.

The formed electrode can be incorporated into a lithium-ion battery according to methods known in the art, for example, as described in “Lithium Ion Batteries Fundamentals and Applications”, by Yuping Wu, CRC press, (2015). In some embodiments, the batteries are coin types such as, for example, 2032 coin-cells, 18650 cylindrical cells, pouch cells, and others. In addition to the cathode containing CNS, e.g., as described above, the battery includes other components, e.g., an anode, and a suitable electrolyte, such as, for instance, ethylene carbonate-dimethyl carbonate-ethylmethyl carbonate (EC-DMC-EMC), vinylene carbonate (VC), LiPF₆; ethylene carbonate-diethlycarbonate (EC-DEC, LiPF₆; or (EC-DMC), LiPF₆. A suitable glass fiber micro filters (Whatman GF/A, for example) or polypropylene/polyethylene membrane (e.g., Celgard 2300) is used as a separator that absorbs electrolyte and prevents electrical contact between electrodes while allowing diffusion of Li ions.

In some of the Li batteries described herein the anode contains an active anode material and a binder (e.g., PVDF, CMC with SBR, etc.) and, in some cases, a conductive additive.

In many implementations, the active anode material is graphite, e.g., natural graphite, artificial graphite or blends of both. Commercially available types of graphite that can be used include mesocarbon microbead (MCMB), mesophase-pitch-based carbon fibre (MCF), vapor grown carbon fiber (VGCF), massive artificial graphite (MAG), natural graphite and others. In other implementations, the active anode compound used comprises, consists essentially of or consists of silicon. In one example, the active anode material is a silicon-graphite composite, graphite containing nanosilicon (Si) or SiOₓ particles.

Examples of other active anode materials include but are not limited to: (a) intercalation/de-intercalation materials (e.g., carbon based materials, porous carbon, carbon nanotubes, graphene, TiO₂, Li₄Ti₅O₁₂, and so forth); (b) alloy/de-alloy materials (e.g., Si, SiOₓ, doped Si, Ge, Sn, Al, Bi, SnO₂, etc.); and (c) conversion materials (e.g., transition metal oxides (MnₓO_{y}, NiO, FeₓO_{y}, CuO, Cu₂O, MoO₂, etc.), metal sulfides, metal phosphides and metal nitrides represented by the formula MₓX_{y}, where X=S, P, N)).

The concentration of the active anode material, e.g., graphite, silicon, lithium titanate (Li₄Ti₅O₁₂), etc., can vary, depending on the particular type of energy storage device. In illustrative examples, the active component is present in the electrode composition in an amount of at least 80% by weight, e.g., at least 85, 90 or 95 wt %, relative to the total weight of the (dry) electrode composition, e.g., in an amount ranging from 80% to 99% by weight, such as, within the range of from about 80 to about 85 wt %, from about 85 to about 88 wt %, from about 88 to about 90 wt %, from about 90 to about 92 wt %, from about 92 to about 95 wt % from about 95 to about 97 wt %, or from about 97 to about 99 wt %, relative to the total weight of the electrode composition.

In some embodiments, the anode composition also contains a conductive additive, such as, for instance a conductive carbon additive (CCA). Examples include CB, CNTs, and so forth. In specific implementations, the anode composition includes CNSs, CNS fragments and/or fractured CNTs. Such anode compositions as well as their preparation and use are described in U.S. Provisional Patent Application No. 62/822,101, filed on Mar. 22, 2019 with the title Anode Electrode Compositions for Battery Applications and in non-provisional U.S. patent application with the title Anode Electrode Compositions for Battery Applications, filed concurrently herewith under Attorney Docket No. 2018613, which are both incorporated herein in their entirety by this reference. In many cases, the CNSs employed to prepare the anode composition are coated, e.g., PU- or PEG-coated. When dried, illustrative anode compositions contain carbon nanostructures, carbon nanostructure fragments and/or fractured nanotubes in an amount no greater than about 1 wt % and, in many cases, no greater than 0.5 wt %.

Thus, in specific embodiments of the invention, both cathode and anode contain CNSs, fragments of CNSs and/or fractured CNTs.

In some implementations, the CNS loading with respect to a dry electrode composition such as used in a graphite negative electrode for LIBs, for instance, is no greater than about 5 wt % and often no greater than about 2 wt %, for example less than 1.9, 1.8, 1.7 or 1.6 wt %. In other embodiments, the CNS loading relative to a dry electrode composition such as used in a graphite anode for LIBs, for instance, is 1.5 wt % or less, e.g., at least 1.4, 1.3, 1.2, 1.2, 1.0, 0.95, 0.90, 0.85, 0.80, 0.75, 0.70, 0.65, 0.60, 0.55, 0.50, 0.45, 0.40, 0.35, 0.30, 0.25, 0.20, 0.15 or 0.10, wt %. In many implementations, the CNS loading relative to a dry electrode composition such as used in a graphite anode for lithium batteries is no greater than 0.5 wt %, e.g., within the rage of from about 0.5 wt % to 0.1 wt %, such as, within the range of from about 0.1 to about 0.2, from about 02 to about 0.3, from about 0.3 to about 0.4, or from about 0.4 to about 0.5 wt %. Other embodiments employ a loading within the range of from about 2 to about 5 wt %, e.g., a loading of at least about 2.25, 2.5, 2.75, 3.0, 3.25, 3.5, 3.75, 4.0, 4.25, 4.5 or 4.75.

The compositions described herein can be used (e.g., incorporated) in electrodes of other energy storage devices, such as, primary alkaline batteries, primary lithium batteries, nickel metal hydride batteries, sodium batteries, lithium sulfur batteries, lithium air batteries, and supercapacitors. Methods of making such devices are known in the art and are described, for example, in “Battery Reference Book”, by TR Crompton, Newness (2000).

Various techniques can be employed to characterize the electrodes, batteries or electrode compositions described herein, and/or identify the presence of CNSs. Examples include but are not limited to electron microscopy, e.g., TEM, SEM, Raman spectrometry, or other suitable qualitative or quantitative analytical methods.

Electrode performance and/or properties can be evaluated by procedures known in the art, or techniques adapted or developed. Suitable techniques include, for instance, in-plane and thru plane electrode conductivity, electrochemical impedance spectroscopy (EIS), constant current charge-discharge, hybrid pulse power capability (HPPC). Some examples are described below.

In applications such as described herein, CNS-based conductive additives perform as well as and often better than CB, individualized CNTs or graphene (a material that presents as a thin sheet of carbon atoms that has high electrical and thermal conductivity and is mechanically strong). For many LIBs, the CNS loading is lower than that needed with other CCAs, CB for example. In one implementation, CNS loadings as low as 0.25 wt % impart good cathode performance, such low loadings being found to be above the percolation threshold (i.e., the lowest concentration at which an insulating material is converted into a conductive material.

In some embodiments, electrodes containing CNSs perform a well as comparative electrodes (made with the same active electrode material, e.g., NCM, solvent and other ingredients, if used, e.g. dispersant) that contain CB at a higher loading. For example, CNS at loadings no higher than 1.5 wt % impart at least as good a performance (expressed as cathode resistance or capacity of a battery made with the electrode, for example) as electrodes containing 2 or more wt % of CB. In other embodiments, electrodes containing a certain CNS loading, e.g., 1.5 wt % or lower, display a better performance (expressed as cathode resistance or capacity of a battery made with the electrode, for example) relative to comparative electrodes containing the same amount of CB.

CB particles that are typically used as CCA in electrodes and that could be employed to prepare comparative cathode formulations often have a Brunauer-Emmett-Teller (BET) surface area greater than 50 m²/g, and an oil adsorption number (OAN) greater than 150 mL/100 g. CNTs and, in particular, MWCNTs, also can be used. Shown in Table 3 below are several illustrative CB and CNT specifications, some of which are referenced in the nonlimiting examples below, presented to further describe aspects of the invention.

TABLE 3

| | | | | | | (I_{G}/(I_{G} + I_{D})) | |
|---|---|---|---|---|---|---|---|
| CB | BET SA, | STSA, | OAN, | # graphitic | Lₐ Raman | % Cr, | L_{c} XRD |
| Specification | m²/g | m²/g | mL/100 g | layers | Å | Raman | Å |
| I | 154 | 135 | 161 | N/A | 31 | 42 | 21 |
| II | 169 | 144 | 155 | N/A | 24 | 38 | 18.8 |
| III | 100 | 100 | 250 | N/A | 27 | 39 | 20.7 |
| IV | 58 | 58 | 200+ | N/A | 27.7 | 38.9 | 19.7 |
| V | 230 | N/A | N/A | 13 | 52.5 | 54.7 | 45.3 |
| VI | 240 | N/A | N/A | 12 | 48.7 | 52.8 | 42.5 |
| VII | 171 | N/A | N/A | NA | 29.3 | 40.2 | 54.9 |
| VIII | 250+ | N/A | N/A | 11 | 27.5 | 38.7 | 38.0 |
| IX | 190 | N/A | N/A | 14 | 49.9 | 53.4 | 48.7 |
| X | 266 | N/A | N/A | N/A | 32.4 | 42.7 | 41.7 |
| XI | 212 | N/A | N/A | 12 | 31.9 | 42.3 | 40.4 |
| XII | 258 | N/A | N/A | N/A | 80.6 | 64.91 | N/A |

### Example 1: CNS Dispersion in NMP

A 0.375% CNS dispersion was prepared in N-methylpyrrolidone (NMP) using a 3 wt. % CNS material coated with a water-soluble polyurethane sizing (PU-coated CNS). The appropriate amount of NMP (99.625% of formulation) was massed into a jacked beaker and brought to a nanoenclosure in secondary containment. The appropriate amount of PU-coated CNS pellets (0.375%) was added to the NMP and incorporated into the solvent. The PU polymer coating on the pellets was ignored in the calculation as it was a very small percentage of the total formulation, namely 0.02% by weight. This mixture was covered and brought back to the lab in a secondary containment. The jacked vessel was connected to the chilled water to prevent excessive heat buildup during processing. The mixture was stirred with a standard overhead mixer while a sonication probe was used to deliver 0.5 kJ/g of energy to the mixture. Sonication duration was 10 min for a 200 g batch size. The vessel was then transferred to a hood where the dispersion was bottled.

### Example 2: Electrode Preparation

Formulations were made at 0.25%, 0.5%, 1.0% and 1.5% CNS, with 1.5% PVDF binder (Arkema Kynar HSV900). The active material was NCM111, Li₁₊ₓ(Ni_{0.33}Co_{0.33}Mn_{0.33})₁₋ₓO₂ (7 micron D50), supplied by BASF TODA Battery Materials LLC and having a mass median diameter (D50) of 7 microns. Slurries were prepared by weighing the appropriate amounts of CNS dispersion, PVDF binder solution (pre-dissolved at 10 wt. % in NMP), NCM111 powder and NMP. Final total solids loadings achieved to generate adequate slurry viscosity for coating are listed on Table 4. Electrode slurries were mixed in one step using a SPEX800 mill for 30 minutes and two zirconia media.

TABLE 4

| CNS Loading | Total solids of paste |
|---|---|
| 0.25% | 56% |
| 0.5% | 41% |
| 1.0% | 26% |
| 1.5% | 20% |

The electrode slurries were coated on aluminum foils using an automated doctor blade coater (Model MSK-AFA-III from MTI Corp.). The NMP was evaporated for 20 minutes in a convection oven set at 80° C. Electrodes pastes were coated at dry electrode loading of 10 mg/cm² and calendared to a density of 2.8 g/cc with a manual roll press.

### Example 3: Electrodes Resistance

Sheet resistance of coated electrodes was measured with a Lucas Lab 302 four-probe stand and an SP4 probe head connected to the rear of a Keithley 2410C source meter. Measurements were performed in a two-wire configuration mode because it was found that four-wire measurements led to a strong contribution of substrate conductivity. The reported values are direct ohm readings from the instrument, at a current of 0.1 milliampere (mA), and a cathode calendered density of 2.8 g/cc. All cathodes tested herein were of the same thickness.

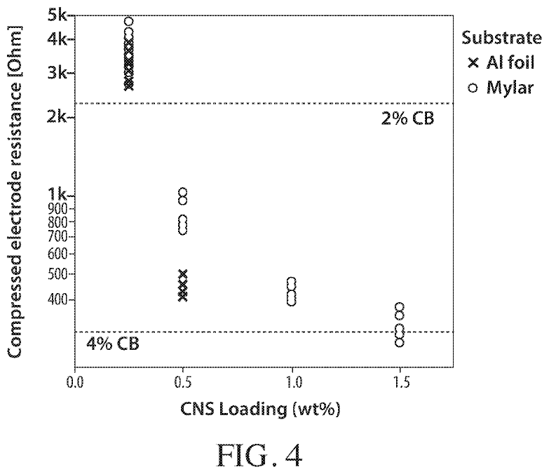

FIG. 4 depicts the resistance obtained from the cathode (active material: lithiated nickel cobalt manganese NCM111; binder: Arkema Kynar HSV-900) sheet on a plastic sheet, e.g., Mylar™ brand, or aluminum foils made with CNS with loading from 0.25 wt % to 1.5 wt %. Resistance of cathode sheets made with 2 wt % and 4 wt % carbon black particles having the properties of specification III in Table 3 are also shown. It is found that 0.5 wt % CNS on both Al foil and Mylar™ sheet showed resistance much lower than 2% CB additive. The resistance measured for the electrode with 1.5% CNS is as good as that observed with 4% carbon additive.

### Example 4: Electrodes Capacity

The cathodes of Example 2 were tested in 2032 coin cells half-cells. Fifteen-millimeter diameter discs were punched for coin-cell preparation and dried at 110° C. under vacuum for a minimum of 4 hours. Discs were calendered to a density of 2.8 g/cc with a manual roll press, and assembled into 2032 coin-cells in an argon-filled glove box (M-Braun) for testing against lithium foil. Glass fiber micro filters (Whatman GF/A) were used as separators. The electrolyte was 100 microliters of ethylene carbonate-dimethyl carbonate-ethylmethyl carbonate (EC-DMC-EMC), vinylene carbonate (VC) 1%, LiPF₆ 1M (BASF). Four coin-cells were assembled for each formulation tested. Reported capacities are averages of the four coin-cells, normalized in milliampere hours per gram (mAh/g) of active cathode mass.

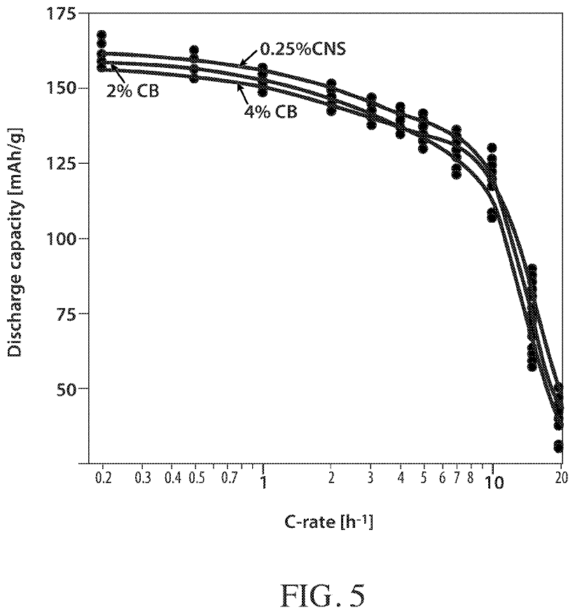

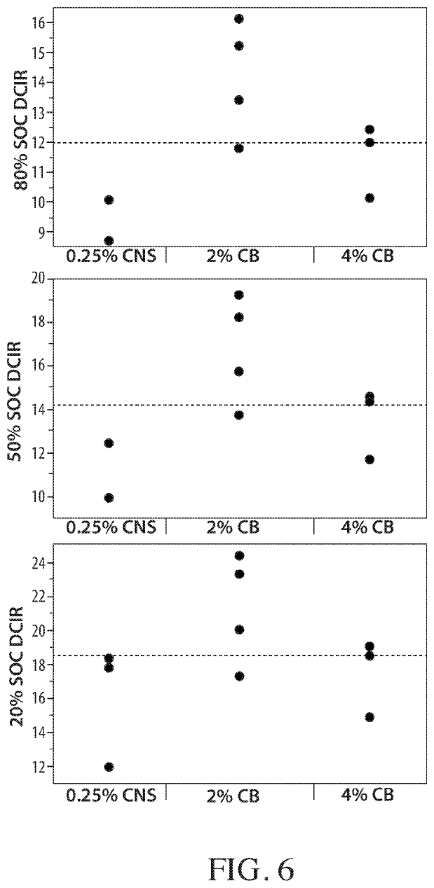

The capacity of half coin cells using the above cathode electrodes comparing 0.25% CNS, 2% CB and 4% CB additive are shown in FIG. 5. Overall, 0.25% CNS showed the best discharge capacity up to 10C c-rate. This can be ascribed to the benefit of reducing conductive additive in electrode (higher loading of). FIG. 6 showed that direct current internal resistance (DCIR) obtained at different state of charge (SOC) of coin cells made with cathodes composed of 0.25 wt % CNS, 2 wt % CB and 4 wt % CB additive, respectively. It was found that at 20, 50 and 80% SOC, 0.25% CNS resulted in the lowest coin cell resistance compared with 2% and 4 wt % CB additive.

### Example 5: Electrodes Preparation with CNS Powder

Active cathode powder (Sanshan NCM622), NMP, 10% solids binder NMP solution (Kureha KF7200) were mixed together for 12 minutes (3*4 minutes active, 3*3 minutes intermittent cooling periods) with a Thinky ARE310 planetary mixer at 70% solids loading. PU coated CNS granules (CNS_PU 3%) were added at 0.5 wt. % of solids and mixing was carried on for another 12 minutes (3*4 minutes active, 3*3 minutes intermittent cooling periods).

After CNS addition, NMP was gradually added to achieve 60% final solids in the slurry and maintain a coatable slurry viscosity.

The electrode slurries were coated on aluminum foils using an automated doctor blade coater (Model MSK-AFA-III from MTI Corp.). The NMP was evaporated for 20 minutes in a convection oven set at 80° C. Electrodes pastes were coated at dry electrode loading of 25 mg/cm² and calendared to a density of 3.5 g/cm³ (g/cc) with a manual roll press. The electrodes solid contents were 98% NCM622, 0.5% CNS and 1.5% KF7200 PVDF binder.

### Example 6: Electrodes Resistance with CNS Dry Powder Additive

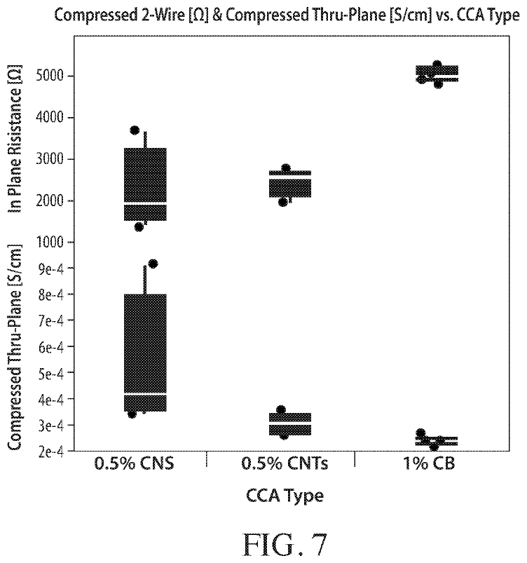

In plane electrodes resistance was measured as described in example 3, comparing electrodes prepared using CNS powder additive to other control electrodes containing 1% carbon black (having the properties of specification III in Table 3) or 0.5% carbon nanotubes (CNTs), having the properties of specification V in Table 3. All electrodes tested herein were of the same thickness. Thru plane electrode resistance was measured using a manual drop gauge with the flat gaging contact head of 7.14 mm diameter connected to the front of a Keithley 2410C source meter. Measurements were performed in a two-wire configuration mode, reported in direct ohm readings from the instrument, at a current of 0.1 milliampere (mA), and a cathode calendered density of 3.5 g/cc, and further converted into thru plane electrode conductivity (in S/m) as reported herein. Characteristics of the electrodes are listed in Table 5. The results, shown in FIG. 7, indicate that 0.5% CNS electrodes have an in-plane resistance similar to that of 0.5% CNTs and half lower than electrodes with 1% CB. The thru plane conductivity is statistically higher than that observed with 0.5% CNTs and 1% CB.

TABLE 5

| | | KF7200 PVDF | Loading, | Density, |
|---|---|---|---|---|
| NCM622 | CCA | binder | mg/cm² | g/cm³ |
| 97.5% | 1% (CB) | 1.5% | 25 | 3.5 |
| 98% | 0.5% CNS_PU (3%) | 1.5% | 25 | 3.5 |
| 98% | 0.5% CNTs | 1.5% | 25 | 3.5 |

### Example 7: Preparation of CNS Dispersion in NMP—Method 2

CNS dispersions were made by first loading the Netzsch Minicer Agitator Bead Mill with media. For these samples, 100 ml of 0.4-0.6 mm yttria stabilized zirconia beads were added to the chamber. This amount equates to a 70% fill of the milling chamber. Then the system was primed with a known amount of NMP. Based on the amount added, the amount of PEG-coated CNS (Cabot Corporation) needed to achieve target loading would be calculated. This amount was then broken down to doses of around 0.2% wt. The system would be set to the preferred operation conditions of 4200 rpm and a pump rate of around 80 ml/min, and the first dose of carbon nanostructures was added. The system was run and monitored until the pressure in the system stabilizes and the dispersion appeared to smooth out. A second dose was added, and the process was repeated until the desired loading was achieved. The energy required to reach ideal state after each dose was longer the further into the process you progress. Finally, after the material was loaded and milled sufficiently, the dispersant was added to the dispersion and allowed to circulate for an additional half an hour to fully incorporate it into the system. The sample was then pumped off into a container and the Minicer mill was flushed to remove remaining material.

Two CNS dispersions have been prepared following this protocol. The composition and PSD, measured by Microtrac instrument, details are summarized in Table 6.

TABLE 6

| | | | | PSD | |
|---|---|---|---|---|---|
| | | | | Mean | |
| | | | | Volume | |
| | CCA | Dispersant | | Diameter | D50 |
| | loading | loading | Dispersant type | (μm) | (μm) |
| CNS-A | 1.6% | 0.32% | PVP-based | 8.6 | 5.9 |
| CNS-B | 1% | 0.2% | PVB/BYK- | 9.0 | 6.4 |
| | | | BYK2155/AMP | | |

### Example 8: Electrode Preparation with CNS Dispersion—Method 2

The conductive carbon materials used for electrode preparation included pre-dispersed CNS particles from Cabot Corporation, as listed Table 6, and commercially available MWCNTs having the properties of specification VI-IX, as listed in Table 3. All CCAs were used in a NMP-based dispersion form. Cathodes were prepared with NCM622 active material from ShanShan (China) and KF7200 PVDF binder from Kureha.

The NCM electrode slurries were made following a two-step mixing protocol with a Thinky planetary centrifugal mixer (model ARE-310). The first step included twelve minutes of active mixing of CNS dispersion with PVDF binder at 2000 rpm; the second step included adding of active NCM622 material and NMP, as needed to adjust viscosity, and active mixing for 12 more minutes at 2000 rpm. The millbase was mixed with two ¼ inch diameter tungsten carbide media during the first step; the slurry was mixed without media in the second step.

The resulting electrode slurries were coated manually on 16-microns-thick aluminum foil using an automated doctor blade coater (Model MSK-AFA-III from MTI Corp.). The target loading was 25 mg/cm² for one side. The NMP was evaporated for 1 hour in a convection oven set for 110° C., and finally dried in a vacuum oven at −100° C. The electrodes were calendared to a density of 3.5 g/cc with a manual roll press.

Fourteen electrode formulations (see Table 7 for details) were prepared for electrode resistance measurements and initial cell performance testing. Two more electrodes of {0.5% CCA:98% NCM622:1.5% PVDF} formulation, where CCA are CNTs having the properties of specification VIII and IX in Table 3, were prepared as comparative examples for electrode resistance test.

TABLE 7

| CCA | CCA | CCA | NCM622 | PVDF |
|---|---|---|---|---|
| Type | Specification | Content | Content | Content |
| CNS | CNS-A | 0.10% | 98.40% | 1.5% |
| | dispersion | 0.25% | 98.25% | 1.5% |
| | | 0.50% | 98.00% | 1.5% |
| | CNS-B | 0.10% | 98.40% | 1.5% |
| | dispersion | 0.25% | 98.25% | 1.5% |
| | | 0.50% | 98.00% | 1.5% |
| CNT | CNT-VI | 0.25% | 98.25% | 1.5% |
| | (see Table 3) | 0.50% | 98.00% | 1.5% |
| | | 0.75% | 97.25% | 1.5% |
| | | 0.10% | 98.40% | 1.5% |
| | CNT-VII | 0.25% | 98.25% | 1.5% |
| | (see Table 3) | 0.50% | 98.00% | 1.5% |
| | | 0.75% | 97.25% | 1.5% |
| | | 1.0% | 97.50% | 1.5% |

### Example 9: Electrodes Resistivity

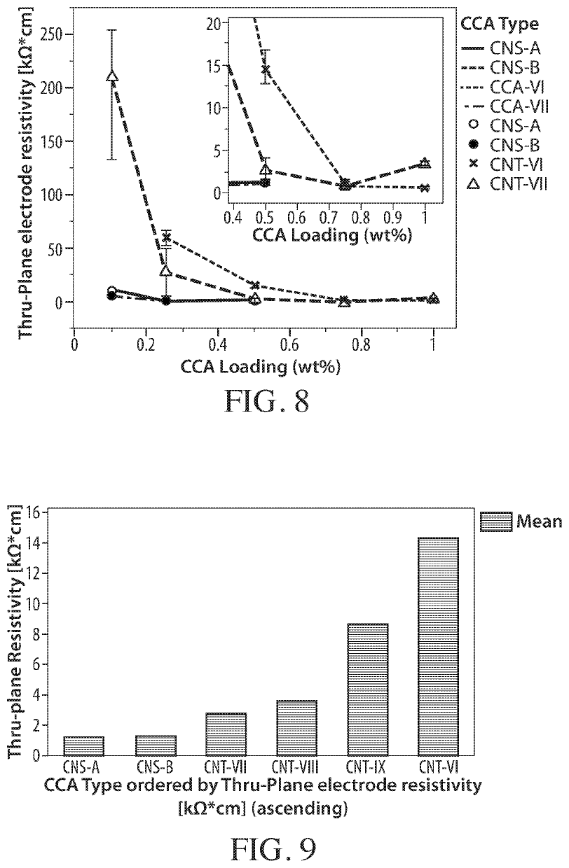

FIG. 8 depicts the electrode through-plane resistivity obtained from the cathode sheets on aluminum foil made with different CCA types (see details in Table 7) as a function of weight percent of CCA content in the electrode ranging from 0.1 wt % to 1.0 wt %. The reported values are derived from direct ohm readings (electrode resistance) measured using a manual drop gauge with the flat gaging contact head of 7.14 mm diameter connected to the front of a Keithley 2410-C source meter. Measurements were performed in a two-wire configuration mode, at a current of 0.1 milliampere (mA), and a cathode calendared density of 3.5 g/cc.

The electrode resistivity is found to vary up to several orders of magnitude depending on the CCA type and improve with higher CCA content. Electrodes with pre-dispersed CNS-A and CNS-B at loadings of 0.25% and 0.5% show the lowest resistivity compared to both multi-walled CNT materials tested at the same loadings. Only at loadings as high as 0.75% and 1% when percolation thresholds are reached, CNT-containing electrodes match the resistivity of 0.25% CNS samples. Data show that CNS requires ˜3 times lesser material by weight to make enough connection points and form a conducting percolation network within the electrode than multi-walled CNTs.

FIG. 9 depicts electrode resistivity of selected electrode formulations with 0.5% CCAs. It confirms that while electrodes with CNS-B are slightly more resistive than with CNS-A when tested at 0.5%, CNS material overall shows the lowest electrode resistivity compared to all multi-walled CNTs tested at the same loading, implying that higher amount of CNT material is needed to match CNS performance.

### Example 10: Initial Cell Performance

The cathode formulations, listed in Table 7, were tested in 2032 half coin-cells. Fifteen-millimeter diameter discs were punched for coin-cell preparation, dried at 100° C. under vacuum for a minimum of 4 hours. Discs were calendered to a density of 3.5 g/cc with a manual roll press, and assembled into 2032 coin-cells in an argon-filled glove box (M-Braun) for testing against lithium foil. Glass fiber micro filters (Whatman GF/A) were used as separators. The electrolyte was 175 microliters of ethylene carbonate-dimethyl carbonate-ethylmethyl carbonate (EC-DMC-EMC), vinylene carbonate (VC) 1%, LiPF6 1M (BASF). Reported capacities are normalized in milliampere hours per gram (mAh/g) of active cathode mass.

Room temperature (25° C.) performance of the half coin-cells was measured by first forming them using two C/5-D/5 charge-discharge cycles, then charging them at C/2 rate and discharging them at C/5, C/2, 1C, 2C, 3C, 4C and 5C discharge rates. Then their Hybrid Pulse Power Capability (HPPC) was tested using 1.5C charge and 2C discharge pulses of 10 s every 10% states of charge from fully charged to fully discharged.

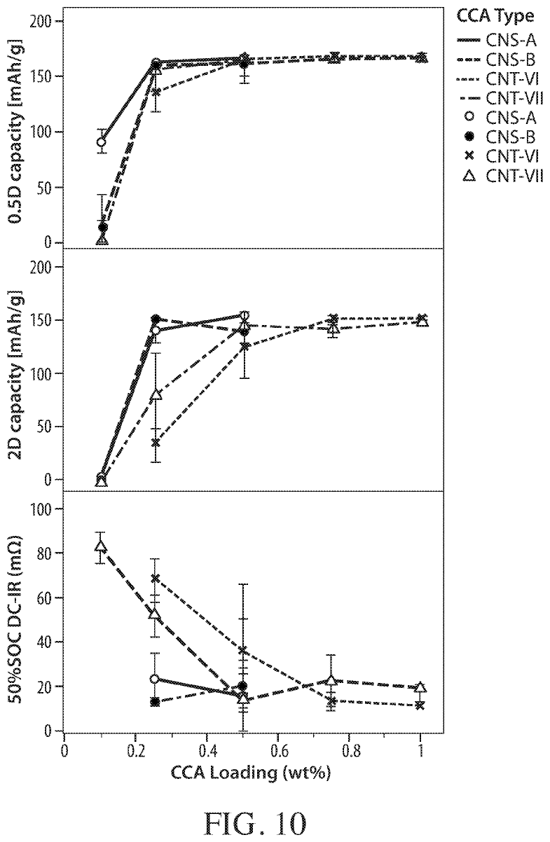

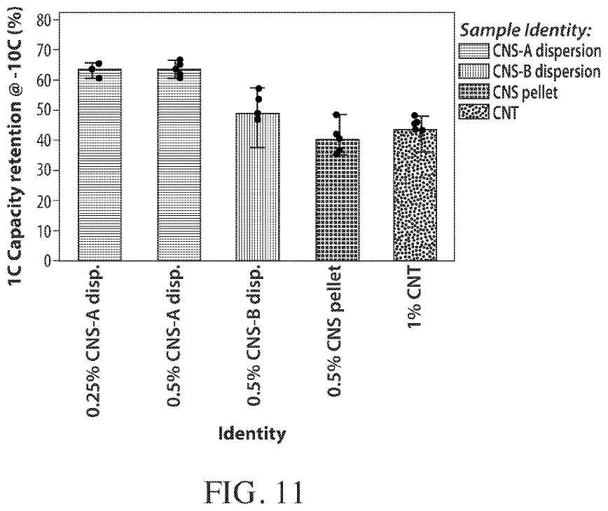

FIG. 10 depicts C-rate capability and DC-IR internal resistance at 50% SOC for the formulations with CCA content ranging from 0.1 wt % to 1.0 wt %, as listed in Table 7. The results indicate that 0.5% CNS-A delivers better initial cell performance than multi-walled CNTs, both in terms of 2C capacity (full discharge in 30 minutes) and DC-IR at 50% SOC. No differentiation is observed at 0.5C capacity since the rate is too slow to reveal impact of CCA type (full discharge in 2 hours). Since CNS reaches the percolation threshold at loadings lower than multi-walled CNTs, the differentiation becomes evident at 0.25%. Both CNS samples (CNS-A and CNS-B) show superior performance over CNTs (here, CNT-VI and CNT-VII) tested at the same 0.25% loading, and are comparable to those at 0.75% and 1.0%.

### Example 11: Low Temperature Performance

Another benefit of CNS over multi-walled CNTs in NCM electrode formulations is the improvement of low temperature performance as demonstrated below. The cathode formulations were tested in half coin-cells, with NCM622 cathodes having an area loading of 25 mg/cm² and a density of 3.5 g/cc. Examples include CNS-A and CNS-B samples pre-dispersed as described in Example 7, CNS pellets, and CNTs (having the properties of specification IX in Table 3) tested at 0.25, 0.5 and 1% CCA loadings, respectively, as detailed in Table 8, below. The low temperature capacity of the half coin-cells was measured by fully charging them at 1 h rate, 25° C. (CC-CV 1C, 4.3V-0.05C) then fully discharging them at 25, 0, −10, −20° C., 1D to 2.8V (1 h rate).

TABLE 8

| CCA identity | | % CCA | % NCM622 | % PVDF |
|---|---|---|---|---|
| CNS-A | Dispersion | 0.25 | 98.25 | 1.5 |
| CNS-A | Dispersion | 0.5 | 98.0 | 1.5 |
| CNS-B | Dispersion | 0.5 | 98.0 | 1.5 |
| CNS | Pellet | 0.5 | 98.0 | 1.5 |
| CNT | Dispersion | 1.0 | 98.0 | 1.0 |

FIG. 11 shows the −10° C. capacity retention of the electrodes (as % of the 25° C. capacity) for the cells with cathode formulation in Table 8. It was found that the cathodes prepared with 0.25% and 0.5% of pre-dispersed CNS-A show −10° C. capacity retention improved by ˜48% as compared to 1% MWCNTs. Cathodes with 0.5% CNS-B overperform those with 1% MWCNTs by ˜13%. Unlike pre-dispersed CNS samples, CNS pellets maintain the same capacity retention as with 1% CNTs but at twice lower loading (capacity retention of 0.5% CNS pellets 1% CNT). These results suggest that CNS material delivers better cell performance at low temperatures than CNTs alone, even at higher loadings. Advantages in low temperature performance may also be associated with providing the CNSs via dispersions.

As used herein, the term “and/or” includes any and all combinations of one or more of the associated listed items. Further, the singular forms and the articles “a”, “an” and “the” are intended to include the plural forms as well, unless expressly stated otherwise. It will be further understood that the terms: includes, comprises, including and/or comprising, when used in this specification, specify the presence of stated features, integers, steps, operations, elements, and/or components, but do not preclude the presence or addition of one or more other features, integers, steps, operations, elements, components, and/or groups thereof. Further, it will be understood that when an element, including component or subsystem, is referred to and/or shown as being connected or coupled to another element, it can be directly connected or coupled to the other element or intervening elements may be present.

It will be understood that although terms such as “first” and “second” are used herein to describe various elements, these elements should not be limited by these terms. These terms are only used to distinguish one element from another element. Thus, an element discussed below could be termed a second element, and similarly, a second element may be termed a first element without departing from the teachings of the present invention.

Unless otherwise defined, all terms (including technical and scientific terms) used herein have the same meaning as commonly understood by one of ordinary skill in the art to which this invention belongs. It will be further understood that terms, such as those defined in commonly used dictionaries, should be interpreted as having a meaning that is consistent with their meaning in the context of the relevant art and will not be interpreted in an idealized or overly formal sense unless expressly so defined herein.

While this invention has been particularly shown and described with references to preferred embodiments thereof, it will be understood by those skilled in the art that various changes in form and details may be made therein without departing from the scope of the invention encompassed by the appended claims.

1. An electrode composition, comprising:
an electroactive material; and
at least one material selected from the group consisting of: carbon nanostructures, fragments of carbon nanostructures and fractured multiwall carbon nanotubes,
wherein the electroactive material is a lithium transition metal compound,
wherein the carbon nanostructures or fragments of carbon nanostructures include a plurality of multiwall carbon nanotubes that are crosslinked in a polymeric structure by being branched, interdigitated, entangled and/or sharing common walls, and
wherein the fractured multiwall carbon nanotubes are derived from carbon nanostructures and are branched and share common walls with one another.

2. The electrode composition of claim 1, wherein:
at least one of the multiwall carbon nanotubes has a length equal to or greater than 2 microns, as determined by SEM,
at least one of the multiwall carbon nanotubes has a length to diameter aspect ratio within a range of from 200 to 1000,
there are at least two branches along a 2-micrometer length of at least one of the multiwall carbon nanotube, as determined by SEM,
at least one multiwall carbon nanotube exhibits an asymmetry in the number of walls observed in the area after a branching point relative to the area prior to the branching point, and/or
no catalyst particle is present at or near branching points, as determined by TEM.

3. The electrode composition of claim 1, wherein the multiwall nanotubes include 2 to 30 coaxial nanotubes, as determined by TEM at a magnification sufficient for counting the number of walls.

4. The electrode composition of claim 1, wherein at least 1% of the carbon nanotubes have a length equal to or greater than 2 microns, as determined by SEM,
a length to diameter aspect ratio within a range of from 200 to 1000, and/or exhibit an asymmetry in the number of walls observed in the area after a branching point relative to the area prior to the branching point.

5. (canceled)

6. (canceled)

7. The composition of claim 1, wherein the at least one material includes carbon nanostructures provided in a dispersion or in the form of a loose particulate material.

8. The composition of claim 1, further comprising a dispersant selected from the group consisting of a PVP-based dispersant, a styrene maleic anhydride-based dispersant, a cellulose-based dispersant, a co-dispersant and any combination thereof.

9. The electrode composition of claim 1, wherein the composition is a paste, a slurry or a solid.

10. The electrode composition of claim 1, wherein the composition further includes a solvent.

11. The electrode composition of claim 10, wherein the solvent is N-methylpyrrolidone.

12. The electrode composition of claim 1, wherein the electrode composition, when dried, contains carbon nanostructures, carbon nanostructure fragments and/or fractured nanotubes in an amount no greater than about 1% by weight.

13. The electrode composition of claim 1, wherein the carbon nanostructures are coated carbon nanostructures.

14. The electrode composition of claim 13, wherein the coated carbon nanostructures are polyurethane-coated nanostructures or polyethylene glycol-coated carbon nanostructures.

15. The electrode composition of claim 13, wherein the weight of the coating relative to the weight of the coated carbon nanostructures is within the range of from about 0.1% to about 10%.

16. The electrode composition of claim 13, wherein the electrode composition, when dried, contains coated carbon nanostructures in an amount no greater than about 1% by weight.

17. The electrode composition of claim 1, further comprising a carbon conductive additive selected from the group consisting of carbon black, individualized carbon nanotubes in pristine form and any combination thereof.

18. The electrode composition of claim 1, further comprising a carbon black, wherein the carbon black has a BET area of 200 m²/g or less and an OAN of at least 130 mL/100 g.

19-21. (canceled)

22. A battery comprising a composition according to claim 1.

23. (canceled)

25. A method for preparing an electrode composition, the method comprising:
combining a dispersion containing at least one material selected from the group consisting of: carbon nanostructures, fragments of carbon nanostructures and fractured multiwall carbon nanotubes with an electroactive material to form a mixture,
wherein the carbon nanostructures or fragments of carbon nanostructures include a plurality of multiwall carbon nanotubes that are crosslinked in a polymeric structure by being branched, interdigitated, entangled and/or sharing common walls,
wherein the fractured multiwall carbon nanotubes are derived from carbon nanostructures and are branched and share common walls with one another, and
wherein the electroactive material is a lithium transition metal compound.

26-43. (canceled)

44. A method for preparing an electrode composition, the method comprising incorporating carbon nanostructures in a slurry which includes an electroactive material,
wherein the electroactive material is a lithium transition metal compound, and
wherein a carbon nanostructure comprises a plurality of multiwall carbon nanotubes that are crosslinked in a polymeric structure by being branched, interdigitated, entangled and/or sharing common walls.

45-68. (canceled)
